(19) United States
(12) Patent Application Publication
(10) Pub. No.: US 2013/0194170 A1
(43) Pub. Date: Aug. 1, 2013

(54) DISPLAY DEVICE

(71) Applicants: Kohji Saitoh, Osaka-shi (JP); Jun Nakata, Osaka-shi (JP); Yoshinori Shibata, Osaka-shi (JP)

(72) Inventors: Kohji Saitoh, Osaka-shi (JP); Jun Nakata, Osaka-shi (JP); Yoshinori Shibata, Osaka-shi (JP)

(73) Assignee: SHARP KABUSHIKI KAISHA, Osaka-shi, Osaka (JP)

(21) Appl. No.: 13/878,804

(22) PCT Filed: Oct. 12, 2011
(86) PCT No.: PCT/JP2011/073430

§ 371 Date: Apr. 11, 2013

(30) Foreign Application Priority Data
Oct. 19, 2010 (JP) 2010-234626

(51) Int. Cl. G09G 3/36

(52) U.S. Cl. CPC G09G 3/3611
USPC 345/103

(57) ABSTRACT

Each pixel (31) includes an R pixel (41), a G pixel (42), and a B pixel (43) for displaying different colors and a W pixel (44) for displaying white obtained by combining the colors displayed in the R pixel (41), the G pixel (42), and the B pixel (43). The driving section (20) drives the R pixel (41), the G pixel (42), and the B pixel (43) with the target gamma curve C0 having the target gamma characteristic γ0 and drives, for each location or each frame, each of at least some of the W pixels (44) with a plurality of gamma curves including a gamma curve C1 having a gamma characteristic γ1 different from the target gamma characteristic γ0 and a gamma curve C2 having a gamma characteristic γ2 different from both the target gamma characteristic γ0 and the gamma characteristic γ1.

### TECHNICAL FIELD

The present invention relates to a display device including a display panel having a plurality of pixels.

### BACKGROUND ART

For a display panel that constitutes a liquid crystal display device or the like, there is a demand for a technique for improving visibility in an oblique direction in order to improve a viewing angle.

Patent Literature 1 discloses a liquid crystal display device that includes (i) a liquid crystal panel having a large number of pixels including a first pixel group and a second pixel group and (ii) a data driving section that applies, to the first pixel group and the second pixel group, a tone voltage corresponding to a first data signal and a tone voltage corresponding to a second data signal, respectively, the first data signal and the second data signal corresponding to respective different gamma constants.

### Citation List

### Patent Literature 1

Japanese Patent Application Publication, Tokukai, No. 2005-352483 A (Publication Date: Dec. 22, 2005)

### SUMMARY OF INVENTION

### Technical Problem

However, the aforementioned conventional art causes a problem that an image different from an intended image is displayed.

For example, the following describes an example in which a geometric pattern such as a black oblique line is displayed by driving pixels by use of the aforementioned conventional art, with reference to FIGS. 13 and 14. FIGS. 13 and 14 are diagrams each illustrating a display area of a conventional display device. FIG. 12 illustrates an image displayed without the use of the technique of driving each pixel with the use of a corresponding one of gamma curves having respective different gamma characteristics, i.e., an image which should originally be displayed on the display area of FIGS. 13 and 14.

In the display area 330 illustrated in FIGS. 12 through 14, a plurality of pixels 331 are arranged in a stripe manner. Here, it is assumed that each of the pixels 331 is made up of four subpixels 341, 342, 343, and 344 for displaying red (R), green (G), blue (B), and white (W), respectively.

One example of the driving method using the aforementioned conventional art, i.e., a driving method of driving each pixel with the use of a corresponding one of gamma curves having respective different gamma characteristics is a method for driving adjacent ones of the pixels 331 with a gamma curve having a gamma characteristic whose relative luminance corresponding to each tone is high (bright) and a gamma curve having a gamma characteristic whose relative luminance corresponding to each tone is low (dark), respectively, as illustrated in FIG. 13. However, according to this method, there arises a case where all of the pixels 331 located in positions (indicated by the dotted rectangles in FIG. 13) on which an oblique line is to be displayed are driven with the use of the gamma curve having the bright gamma characteristic. This results in a problem that the oblique line, which should be displayed, is not displayed.

Moreover, according to the conventional art, in a case where an image such as a character or a geometric pattern, which has an oblique line, is to be displayed, there is a risk that part of the image is not displayed, so that an edge in an image is displayed with aliasing and the image is displayed unsmoothly. As has been described, according to the conventional art, there arises a problem that an image different from an intended image is displayed.

Another example of the driving method using the aforementioned conventional art is a method for driving each of the subpixels 341, 342, 343, and 344 with the use of a corresponding one of gamma curves having respective different gamma characteristics as illustrated in FIG. 14. However, according to this method, there arises a case where in all of the pixels 331 located in positions (indicated by the dotted rectangles in FIG. 14) on which an oblique line is to be displayed, the subpixels 341 and 343 for displaying R and B are driven with the use of a gamma curve having a bright gamma characteristic, whereas the subpixels 342 and 344 for displaying G and W are driven with the use of a gamma curve having a dark gamma characteristic. This causes a problem that a displayed oblique line has a color, such as purple, that is different from a color that should originally be displayed.

Moreover, a viewing angle characteristic and a chromaticity characteristic of a subpixel vary depending on a color displayed in the subpixel. Accordingly, there arises a problem that a color aberration occurs between a case where the display area is viewed from front and a case where the display area is viewed in an oblique direction. FIG. 10 illustrates a positional relation between (i) a case where the display area 330 is viewed from front (in a normal direction) and (ii) a case where the display area 330 is viewed from a position at a viewing angle of 60° (in an oblique direction at 60°). FIG. 11 is a view illustrating tone characteristics of R, G, B, and W which are obtained when the display area of the conventional display device is viewed from a position at a viewing angle of 60°, in a case where the tone characteristics of R, G, B, and W obtained when the display area is viewed from front have been adjusted so as to be closer to a gamma curve C10 having a gamma characteristic of 2.2 (γ=2.2). In FIG. 11, the curve C11 represents a tone characteristic of R, the curve C12 represents a tone characteristic of G, the curve C13 represents a tone characteristic of B, and the curve C14 represents a tone characteristic of W.

As is clear from FIG. 11, even in a case where the tone characteristics of R, G, B, and W which are obtained when the display area is viewed from front are adjusted to be equal to each other, the tone characteristics of R, G, B, and W are different from each other when the display area is viewed in the oblique direction. This shows that a viewing angle characteristic and a chromaticity characteristic of a subpixel vary depending on a color displayed in the subpixel.

As a solution for the problem that color aberration occurs according to the conventional art, there is a method of driving subpixels with the use of gamma curves that have been adjusted individually for respective colors. However, use of this method causes a further problem that a configuration of an image processing section becomes complicated.

With reference to FIG. 15, the following describes how an image processing section is configured in a case where subpixels are driven with the use of gamma curves that have been adjusted individually for respective colors. FIG. 15 is a block diagram illustrating a configuration of an image processing section 322 of a conventional display device.

The image processing section 322 includes an RGBW developing section 351 and a tone characteristic adjusting section 352. The RGBW developing section 351 generates Red data (hereinafter referred to as “R data”), Green data (hereinafter referred to as “G data”), Blue data (hereinafter referred to as “B data”), and White data (hereinafter referred to as “W data”) from RGB data received from a video data processing section (not illustrated).

The tone characteristic adjusting section 352 includes an R data processing section 353, a G data processing section 354, a B data processing section 355, and a W data processing section 356. The R data processing section 353 carries out processing of generating adjusted R data from the R data generated in the RGBW developing section 351 in order to drive a subpixel for displaying red with the use of a gamma curve adjusted individually for the subpixel for displaying red. Similarly, the G data processing section 354, the B data processing section 355, and the W data processing section 356 process the G data, the B data, and the W data, respectively.

It is thus necessary to adjust gamma curves individually for R, G, B, and W in a case where subpixels are driven with the use of gamma curves adjusted for respective colors. This increases a size of a circuit in the image processing section, thereby leading to further problems such as a rise in cost and a rise in power consumption.

The present invention is accomplished in view of the above problems, and an object of the present invention is to provide a display device that can display an image closer to an intended image while preventing, at lower cost, a color aberration that occurs when viewed in an oblique direction.

### Solution to Problem

In order to attain the object, a display device of the present invention includes a display panel having a plurality of pixels; and

driving means for driving the plurality of pixels, each of the plurality of pixels being made up of (i) a plurality of first subpixels for displaying respective different colors and (ii) a second subpixel for displaying a mixed color that is obtained by mixing arbitrary ones of the different colors, the driving means driving the plurality of first subpixels with use of a common gamma curve that has a predetermined gamma characteristic, and the driving means driving, for each location, each of at least some of the second subpixels with use of any of a plurality of gamma curves including (i) a first gamma curve having a first gamma characteristic that is different from the predetermined gamma characteristic and (ii) a second gamma curve having a second gamma characteristic that is different from both the predetermined gamma characteristic and the first gamma characteristic.

In order to attain the object, a display device of the present invention includes a display panel having a plurality of pixels; and

driving means for driving the plurality of pixels, each of the plurality of pixels being made up of (i) a plurality of first subpixels for displaying respective different colors and (ii) a second subpixel for displaying a mixed color that is obtained by mixing arbitrary ones of the different colors, the driving means driving the plurality of first subpixels with use of a common gamma curve that has a predetermined gamma characteristic, and the driving means driving, for each frame, each of at least some of the second subpixels with use of any of a plurality of gamma curves including (i) a first gamma curve having a first gamma characteristic that is different from the predetermined gamma characteristic and (ii) a second gamma curve having a second gamma characteristic that is different from both the predetermined gamma characteristic and the first gamma characteristic.

According to the configuration, the plurality of first subpixels, which are included in each pixel and are subpixels for displaying respective different colors, are uniformly driven by the driving means with the use of the common gamma curve. This makes it possible to eliminate cases (i) where an oblique line to be displayed is not displayed and (ii) where an intended color to be displayed becomes an unintended color.

The driving means drives, for each location or frame, each of at least some of the second subpixels, each of which is a subpixel for displaying a mixed color that is obtained by mixing arbitrary ones of the different colors in each pixel, with the use of any of a plurality of gamma curves including different two gamma curves. With the configuration, gamma characteristics of the second subpixels are mutually compensated, and therefore color aberration that occurs when viewed in an oblique direction can be prevented. This allows an improvement in viewing angle characteristic.

The driving means drives, for each location or frame, only the second subpixels in each pixel with the use of any of the plurality of gamma curves including the different two gamma curves, while uniformly driving the plurality of first subpixels in the each pixel with the use of the common gamma curve. This allows a simplification in configuration of the driving means, and it is therefore possible to reduce cost and power consumption.

### Advantageous Effects of Invention

As above described, the display device of the present invention includes a display panel having a plurality of pixels; and

driving means for driving the plurality of pixels, each of the plurality of pixels being made up of (i) a plurality of first subpixels for displaying respective different colors and (ii) a second subpixel for displaying a mixed color that is obtained by mixing arbitrary ones of the different colors, the driving means driving the plurality of first subpixels with use of a common gamma curve that has a predetermined gamma characteristic, and the driving means driving, for each location or frame, each of at least some of the second subpixels with use of any of a plurality of gamma curves including (i) a first gamma curve having a first gamma characteristic that is different from the predetermined gamma characteristic and (ii) a second gamma curve having a second gamma characteristic that is different from both the predetermined gamma characteristic and the first gamma characteristic. This makes it possible (i) to display an image that is closer to an intended image to be displayed and (i) to prevent, at low cost, color aberration from occurring when viewed in an oblique direction.

For a fuller understanding of the other objects, natures, excellent points, and advantages of the present invention, reference should be made to the ensuing detailed description taken in conjunction with the accompanying drawings.

### BRIEF DESCRIPTION OF DRAWINGS

FIG. 1

FIG. 1 is a view illustrating a display area of a display device in accordance with an embodiment of the present invention.

FIG. 2

FIG. 2 is a view illustrating a configuration of a display device in accordance with an embodiment of the present invention.

FIG. 3

FIG. 3 is a graph illustrating an example of a gamma curve used by a driving section of a display device, in accordance with an embodiment of the present invention.

FIG. 4

FIG. 4 is a view illustrating a display area of a display device in accordance with another embodiment of the present invention.

FIG. 5

Each of (a) and (b) of FIG. 5 is a view illustrating a display area of a display device in accordance with another embodiment of the present invention.

FIG. 6

Each of (a) through (c) of FIG. 6 is a view illustrating a display area of a display device in accordance with another embodiment of the present invention.

FIG. 7

Each of (a) and (b) of FIG. 7 is a view illustrating a display area of a display device in accordance with another embodiment of the present invention.

FIG. 8

Each of (a) through (c) of FIG. 8 is a view illustrating a display area of a display device in accordance with another embodiment of the present invention.

FIG. 9

FIG. 9 is a view illustrating a display area of a display device in accordance with another embodiment of the present invention.

FIG. 10

FIG. 10 illustrates a positional relation between (i) a case where a display area is viewed from front (in a normal direction) and (ii) a case where the display area is viewed from a position at a viewing angle of 60° (in an oblique direction at 60°).

FIG. 11

FIG. 11 is a view illustrating tone characteristics of R, G, B, and W which are obtained when a display area of a conventional display device is viewed from a position at a viewing angle of 60°, in a case where the tone characteristics of R, G, B, and W obtained when the display area is viewed from front have been adjusted so as to be closer to a gamma curve (γ=2.2).

FIG. 12

FIG. 12 illustrates an original image of images which are to be displayed on a display area and are illustrated in FIGS. 13 and 14.

FIG. 13

FIG. 13 is a view illustrating a display area of a conventional display device.

FIG. 14

FIG. 14 is a view illustrating a display area of a conventional display device.

FIG. 15

FIG. 15 is a block diagram illustrating a configuration of an image processing section of a conventional display device.

### DESCRIPTION OF EMBODIMENTS

### Embodiment 1

The following description will discuss an embodiment of the present invention in detail.

(Configuration of display device 1)

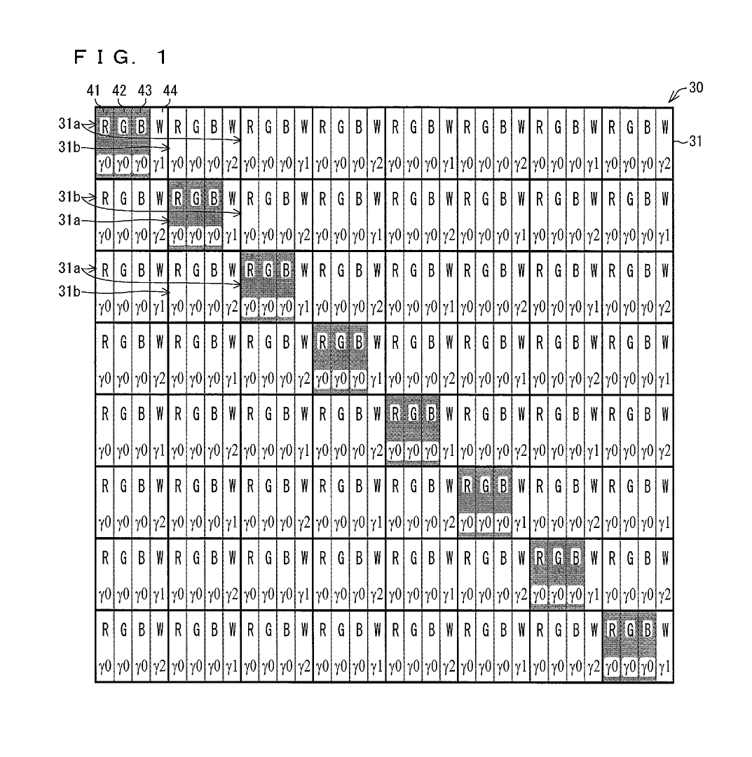

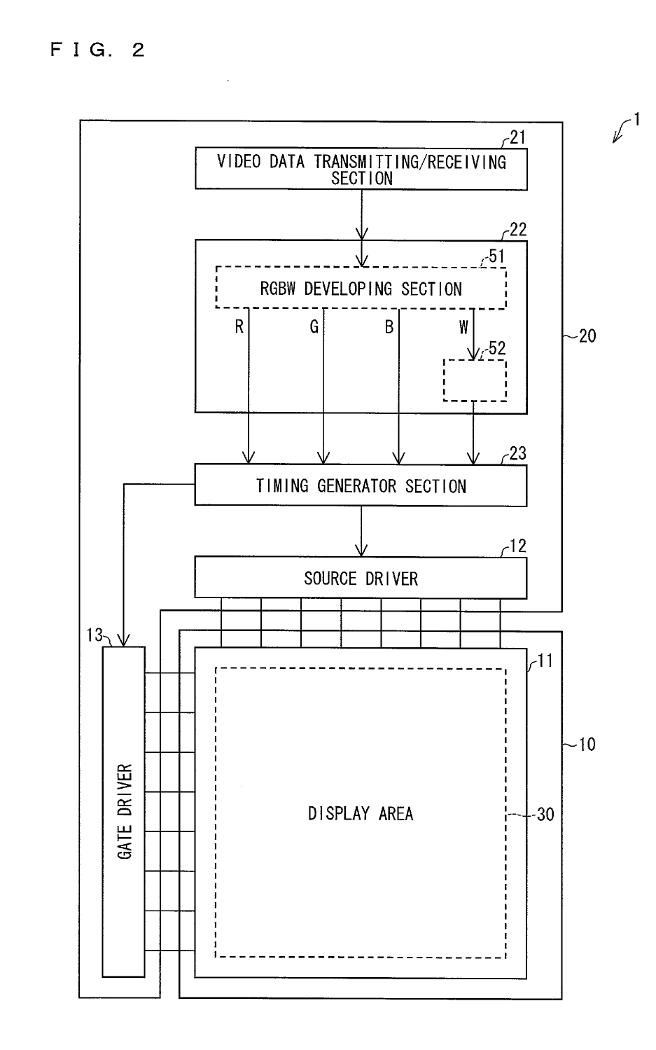

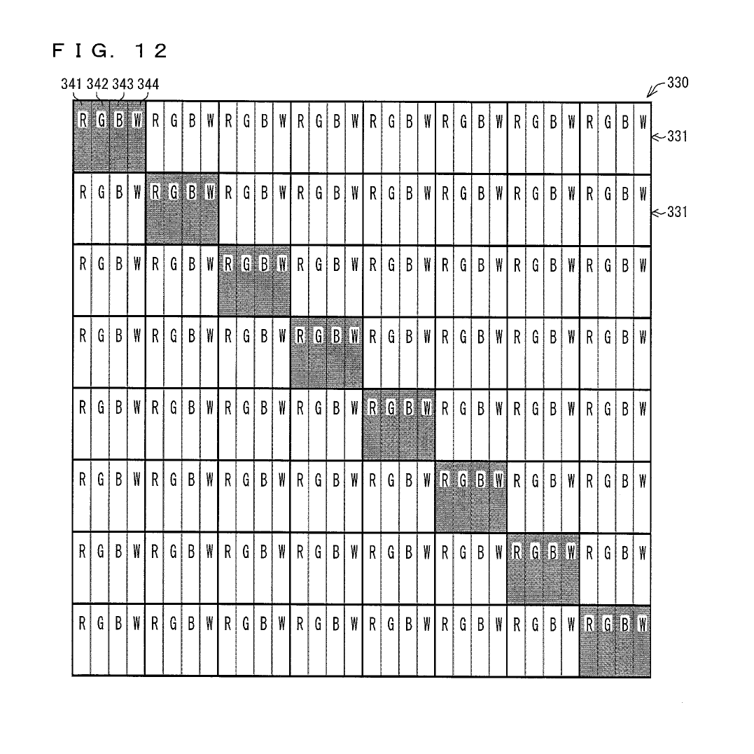

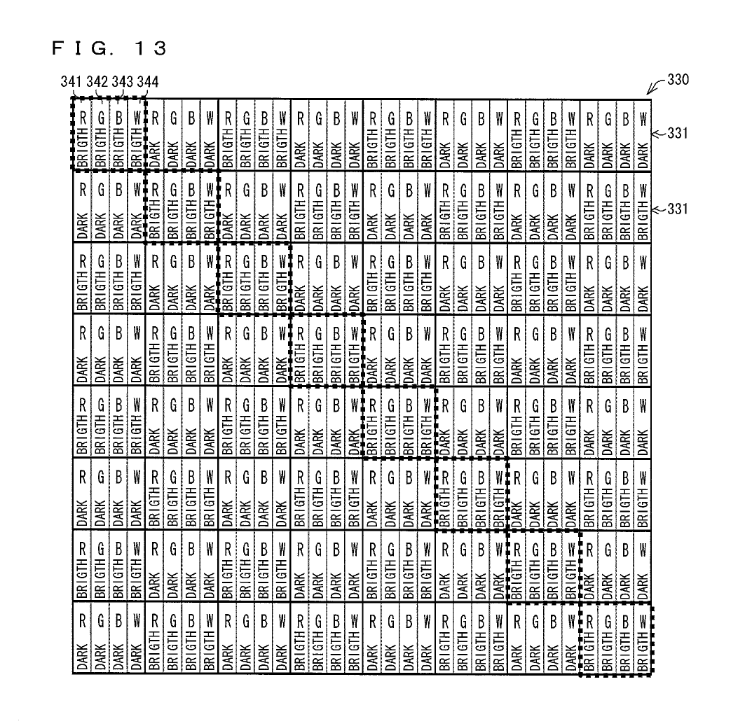

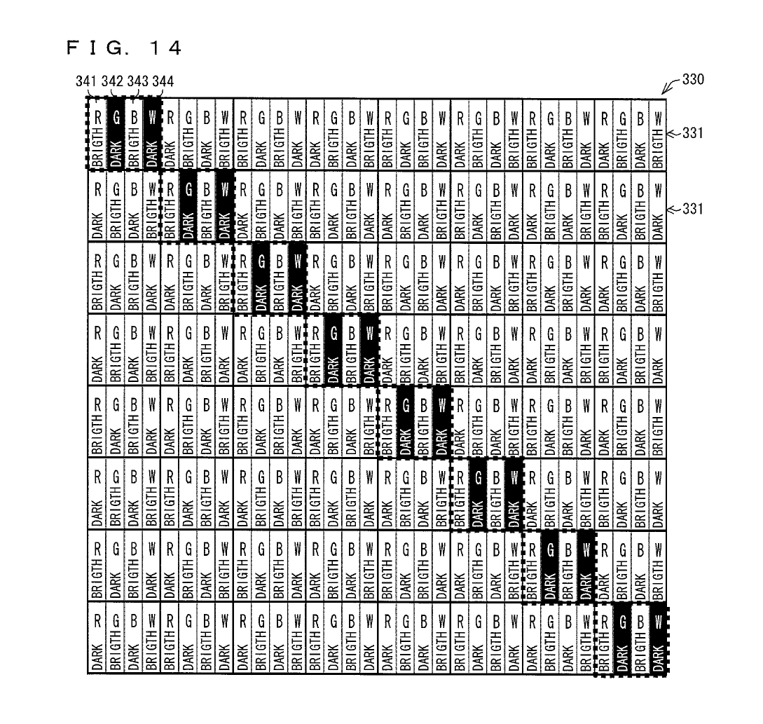

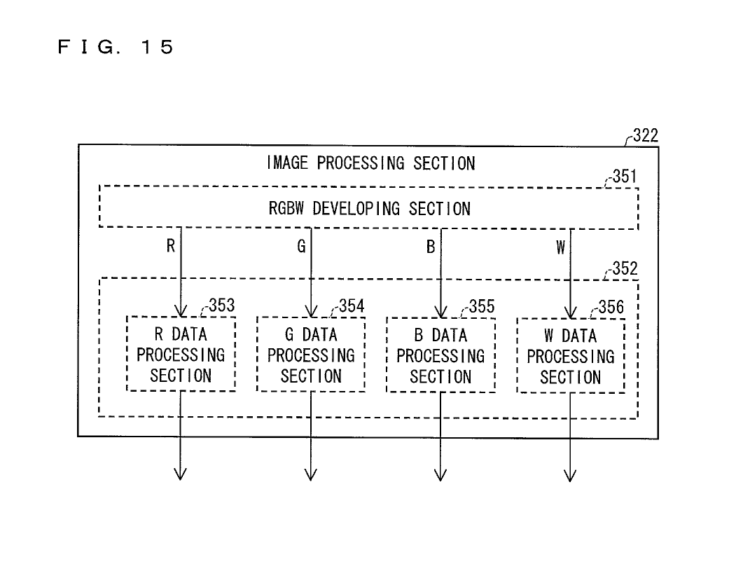

The following description will discuss a configuration of a display device 1 in accordance with Embodiment 1, with reference to FIGS. 1 and 2. FIG. 1 is a view illustrating a display area of a display device in accordance with an embodiment of the present invention. FIG. 2 is a view illustrating a configuration of a display device in accordance with an embodiment of the present invention. Note that FIG. 1 illustrates a case where an image illustrated in FIG. 12 is an original image that is intended to be displayed.

The display device 1 of Embodiment 1 includes a display panel 10 and a driving section (driving means) 20. The display panel 10 includes a display section 11 having a display area 30. In the display area 30, a plurality of pixels 31 are provided.

Embodiment 1 employs a configuration in which the plurality of pixels 31 are arranged in a stripe pattern. Note, however, that the present invention is not limited to this, and the plurality of pixels may be arranged in, for example, a deltoid pattern.

Each of the plurality of pixels 31 is made up of four subpixels, i.e., an R pixel (first subpixel, red pixel) 41 for displaying red, a G pixel (first subpixel, green pixel) 42 for displaying green, a B pixel (first subpixel, blue pixel) 43 for displaying blue, and a W pixel (second subpixel, white pixel) 44 for displaying white. In Embodiment 1, the R pixel 41, the G pixel 42, the B pixel 43, and the W pixel 44 are aligned in one (1) direction in one (1) pixel 31.

The W pixel 44 is a subpixel for displaying white which is obtained by mixing red, green, and blue that are displayed in respective three subpixels, i.e., the R pixel 41, the G pixel 42, and the B pixel 43.

In Embodiment 1, a configuration is described in which one (1) pixel is made up of three first subpixels and one (1) second subpixel. Note, however, that the present invention is not limited to this in particular. Alternatively, one (1) pixel in the present invention may be made up of (i) two first subpixels or four or more first subpixels and (ii) two or more second subpixels.

In Embodiment 1, the first subpixels and the second subpixel are aligned in one (1) direction in one (1) pixel. Note, however, that the present invention is not limited to this in particular. Alternatively, the first subpixels and the second subpixel may be arranged, for example, in a matrix of m×n or in a deltoid pattern in one (1) pixel. In this case, “m” and “n” are natural numbers not smaller than 2 and may be identical or different natural numbers.

Colors displayed in respective of a plurality of first subpixels included in one (1) pixel are not limited in particular, provided that the colors are different from each other. A combination of colors that are displayed in the respective plurality of first subpixels is not limited to the combination of red, green, and blue. However, it is preferable that the combination of colors is a combination of primary colors. Examples of the combination of colors displayed in the respective plurality of first subpixels encompass a combination of cyan, magenta, and yellow.

Embodiment 1 employs the second pixel for displaying white. Note, however, that the present invention is not limited to this in particular. That is, the second pixel of the present invention is not limited in particular, provided that the second pixel is a subpixel for displaying a mixed color obtained by combining colors displayed in respective arbitrary ones of the plurality of first subpixels. First subpixels to be combined can be selected arbitrarily, and the number of combined first pixels may be two or more. In other words, all of or part of a plurality of first subpixels included in one (1) pixel may be combined.

In this specification, the term “mixed color” indicates a color obtained by mixing colors displayed in respective arbitrary ones of the plurality of first subpixels. In a case where the plurality of first subpixels are respective subpixels for displaying red, green, and blue, a color displayed in the second subpixel is preferably white in order to effectively prevent color aberration from occurring when viewed in an oblique direction. Note, however, that, the color displayed in the second subpixel may be a color such as yellow or cyan. Alternatively, in a case where the colors displayed in the plurality of first subpixels are respective cyan, magenta, and yellow, the color displayed in the second subpixel may be a color such as white.

In Embodiment 1, one (1) pixel 31 has one (1) second subpixel. Note, however, that the present invention is not limited to this in particular. Alternatively, one (1) pixel of the present invention may have two or more second subpixels.

The driving section 20 includes a video data transmitting/receiving section 21, an image processing section 22, a timing generator section 23, a source driver 12, and a gate driver 13. The driving section 20 having such a configuration drives the plurality of pixels 31, specifically, the R pixel 41, the G pixel 42, the B pixel 43, and the W pixel 44 which are a plurality of subpixels constituting one (1) pixel 31.

The video data transmitting/receiving section 21 receives video data and transmits the video data to the image processing section 22. The image processing section 22 includes an RGBW developing section 51 and a tone characteristic adjusting section 52.

The RGBW developing section 51 (i) receives video data from the video data transmitting/receiving section and (ii) generates, based on a tone (input tone) indicated in the video data, R data, G data, B data, and W data which are pieces of tone data corresponding to relative luminances to be outputted by respective of the R pixel 41, the G pixel 42, the B pixel 43, and the W pixel 44. Then, the RGBW developing section 51 (i) transmits the R data, the G data, and the B data to the timing generator section 23 as they are and (ii) transmits the W data to the tone characteristic adjusting section 52.

The RGBW developing section 51 uniformly generates R data, G data, B data, and W data based on a predetermined target gamma curve (common gamma curve) C0. The target gamma curve C0 is a curve having a target gamma characteristic (predetermined gamma characteristic) γ0. Note that information regarding the predetermined target gamma curve may be stored, for example, in a storage section (not illustrated).

The term “target gamma curve” indicates a gamma curve used when all pixels 31 of the display panel 10 are driven by an identical gamma curve, and the term “target gamma characteristic” is a gamma characteristic which the target gamma curve has. The target gamma curve may be, for example, a gamma curve that is derived by a general method based on a characteristic and the like of the display device 1 so that excellent visibility viewed from front can be obtained.

Embodiment 1 discusses a case where the predetermined gamma characteristic is the target gamma characteristic and the common gamma curve is equal to the target gamma curve. Note, however, that Embodiment 1 is not limited to this. The wording “the common gamma curve is equal to the target gamma curve” encompasses not only a case where the common gamma curve is completely identical with the target gamma curve but also a case where a substantially identical effect is brought about even though the common gamma curve is not completely identical with the target gamma curve. That is, even in a case where the common gamma curve is slightly different from the target gamma curve, the common gamma curve can be considered as a gamma curve that is equal to the target gamma curve, provided that the common gamma curve brings about an effect that is substantially identical with that brought about when the target gamma curve is employed.

It is preferable that the target gamma characteristic γ0 falls within a range between 1.7 and 2.7. This makes it possible to obtain excellent visibility.

The target gamma curve C0 may be a curve that has one (1) inflection point. This makes it possible to enhance an effect of mutual compensation of gamma characteristics and to obtain excellent visibility. Moreover, the target gamma curve C0 having the one (1) inflection point allows a steep change in tone-luminance characteristic of a halftone region which is often used in a natural image. This makes it possible to heighten contrast that is felt when viewed with eyes (contrast feeling).

The tone characteristic adjusting section 52 converts pieces of W data, which correspond to respective W pixels 44, into individual pieces of adjusted W data. Specifically, the tone characteristic adjusting section 52 first obtains information that is indicative of a predetermined condition for associating any of a plurality of gamma curves with each of the W pixels 44. The information may be stored, for example, in a storage section (not illustrated). Based on the information, the tone characteristic adjusting section 52 associates any of the plurality of gamma curves with each of the W pixels 44. Then, the tone characteristic adjusting section 52 converts pieces of W data corresponding to the respective W pixels 44 into respective pieces of adjusted W data based on gamma curves associated with the respective W pixels 44. Subsequently, the tone characteristic adjusting section 52 transmits the pieces of adjusted W data, which correspond to the respective W pixels 44, to the timing generator section 23.

The timing generator section 23 (i) transmits the R data, the G data, the B data, and the adjusted W data to the source driver 12 and (ii) transmits, to the gate driver 13, a signal for determining timing of driving each pixel 31.

The gate driver 13 drives each of the pixels 31 based on the signal received from the timing generator section 23. The source driver 12 (i) converts the R data, the G data, the B data, and the adjusted W data, which have been received from the timing generator section 23, into respective analog voltages to be actually applied to a pixel and (ii) supplies the analog voltages to each of the pixels 31.

Specifically, the driving section 20 uniformly drives the R pixel 41, the G pixel 42, and the B pixel 43 with the use of a predetermined target gamma curve. Moreover, the driving section 20 drives each of the W pixels 44 with the use of a gamma curve that is associated with the each of the W pixels 44.

According to Embodiment 1, the three subpixels, i.e., the R pixel 41, the G pixel 42, and the B pixel 43, which are provided for displaying respective different colors, i.e., red, blue, and green, are driven by the driving section 20 with the use of the target gamma curve C0. This makes it possible to eliminate cases (i) where an oblique line to be displayed is not displayed and (ii) where an intended color to be displayed becomes an unintended color.

The driving section 20 drives the W pixel 44, which displays white that is a mixed color obtained by combining the three colors displayed in respective of the R pixel 41, the G pixel 42, and the B pixel 43, with the use of any of a plurality of gamma curves. The plurality of gamma curves include at least (i) a gamma curve (first gamma curve) C1 having a gamma characteristic (first gamma characteristic) γ1 different from the target gamma characteristic γ0 and (ii) a gamma curve (second gamma curve) C2 having a gamma characteristic (second gamma characteristic) γ2 different from both the gamma characteristic γ0 and the gamma characteristic γ1. That is, the driving section 20 drives at least some of the W pixels 44 with the use of any of the gamma curve C1 and the gamma curve C2. In other words, the driving section 20 drives at least some of the W pixels 44 by a halftone grayscale method with the use of the gamma curve C1 and the gamma curve C2. With the configuration, gamma characteristics of the W pixels 44 are mutually compensated, and therefore color aberration that occurs when the display area 30 is viewed in an oblique direction can be prevented. This allows an improvement in viewing angle. Note that the plurality of gamma curves used to drive the W pixels 44 may further include a gamma curve(s) in addition to the gamma curves C1 and C2.

The “halftone grayscale method” is a method of driving a plurality of pixels (subpixels) with the use of any of gamma curves that have respective of a plurality of different gamma characteristics. According to the halftone grayscale method, a gamma curve used to drive each pixel is selected by (i) a method of selecting a gamma curve for each spatial location of the pixel or (ii) a method of selecting a gamma curve for each frame. In the present invention, only one of these methods may be used. Alternatively, both of these methods may be used simultaneously.

As above described, the driving section 20 drives only the W pixel 44 out of the subpixels in the pixel 31 with the halftone grayscale method. With the configuration, it is possible to reduce a circuit scale of the driving section 20, as compared with a case where all subpixels are driven by the halftone grayscale method. This allows a simplification in configuration of the driving section 20, and accordingly it is possible to reduce cost and power consumption.

The predetermined condition for associating any of the plurality of gamma curves with each of the W pixels may be (i) a condition for selecting any of the plurality of gamma curves based on a spatial location of a pixel that has the W pixel 44 to be associated with a selected gamma curve or (ii) a condition for selecting any of the plurality of gamma curves, which is to be associated with each of the W pixels 44, for each frame of an image. Alternatively, the predetermined condition may be a condition for selecting any of the plurality of gamma curves for each frame of an image based on a spatial location of a pixel that has the W pixel 44 to be associated with a selected gamma curve.

(Pixel Groups 31a and 31b)

In Embodiment 1, the plurality of pixels 31 includes a pixel group (first pixel group) 31a and a pixel group (second pixel group) 31b. The pixel group 31a and the pixel group 31b are disposed in respective different locations. According to Embodiment 1, pixels 31 belonging to the pixel group 31a and pixels 31 belonging to the pixel group 31b are alternately arranged in the stripe pattern. In other words, a certain pixel 31 and an adjacent pixel 31 adjacent to the certain pixel 31 belong to respective different ones of the pixel groups 31a and 31b.

The “adjacent pixel 31 adjacent to the certain pixel 31” indicates (i) a pixel 31 that is located in a row in which the certain pixel 31 is also located and in a column which is immediately next to a column in which the certain pixel 31 is located or (ii) a pixel 31 that is located in a column in which the certain pixel 31 is also located and in a row which is immediately next to a row in which the certain pixel 31 is located.

Note that, in a case where the plurality of pixel groups are “disposed in respective different locations”, this means that a location in which a pixel of a certain pixel group is disposed is different from a location in which a pixel of another pixel group is disposed. In Embodiment 1, an example of locations of pixel groups are described in which pixels are arranged in a stripe pattern and two pixel groups are provided. Note, however, that the present invention is not limited to this. For example, in a case where a plurality of pixels are arranged in a deltoid pattern and include three pixel groups, arbitrarily selected three pixels that are arranged in a triangular pattern may include (i) a pixel belonging to a first pixel group, (ii) a pixel belonging to a second pixel group, and (iii) a pixel belonging to a third pixel group. In this case, the pixel belonging to the first pixel group, the pixel belonging to the second pixel group, and the pixel belonging to the third pixel group are arranged in a staggered manner.

(Driving Method)

The following description will discuss how each pixel 31 is driven by the driving section 20. In particular, the following description will discuss an example of a predetermined condition for associating each W pixel 44 with any of a plurality of gamma curves.

The driving section 20 drives the R pixel 41, the G pixel 42, and the B pixel 43 with the use of the target gamma curve C0.

In Embodiment 1, the tone characteristic adjusting section 52 of the driving section 20 associates each of the W pixels 44 with a gamma curve on a condition predetermined as below. The tone characteristic adjusting section 52 associates each of the W pixels 44 with (i) a gamma curve C1 having a gamma characteristic γ1 or (ii) a gamma curve C2 having a gamma characteristic γ2.

The tone characteristic adjusting section 52 (i) associates W pixels 44 included in pixels 31 belonging to the pixel group 31a with the gamma curve C1 and (ii) associates W pixels 44 included in pixels 31 belonging to the pixel group 31b with the gamma curve C2.

That is, the driving section 20 (i) drives W pixels 44 included in pixels 31 belonging to the pixel group 31a with the use of the gamma curve C1 and (ii) drives W pixels 44 included in pixels 31 belonging to the pixel group 31b with the use of the gamma curve C2. In other words, the driving section 20 drives, for each location, all the W pixels 44 with the use of any of different two gamma curves, i.e., the gamma curves C1 and C2.

With the configuration, the driving section 20 drives all the W pixels 44 by the halftone grayscale method with the use of the gamma curves C1 and C2 having the respective different gamma characteristics, i.e., the gamma characteristics γ1 and γ2. This makes it possible to further enhance the effect of mutual compensation of gamma characteristics of the W pixels 44 and to further improve a viewing angle.

As illustrated in FIG. 1, the display device 1 of Embodiment 1 can display an image further similar to an oblique line which is an intended image illustrated in FIG. 12. In Embodiment 1, the first subpixels for displaying the primary colors red, green, and blue are driven with the use of the target gamma curve C0. This makes it possible to eliminate a case where the oblique line is not displayed. Moreover, it is possible to eliminate a case where an edge in an image is displayed with aliasing and the image is displayed unsmoothly, which are caused because a part of the image is not displayed. Further, it is possible to display a color that is further similar to an intended color of the image. Therefore, the display device 1 can display an image that is further similar to an intended image to be displayed.

Note that, in a case where the driving section 20 carries out driving with the driving method above described, the driving section 20 may drive the W pixels 44 with the use of an identical gamma curve in all frames or with the use of different gamma curves for each frame. An example will be described in Embodiment 5 in which the W pixels 44 are driven by a combination of the driving method of Embodiment 1 and a driving method carried out with the use of different gamma curves for each frame.

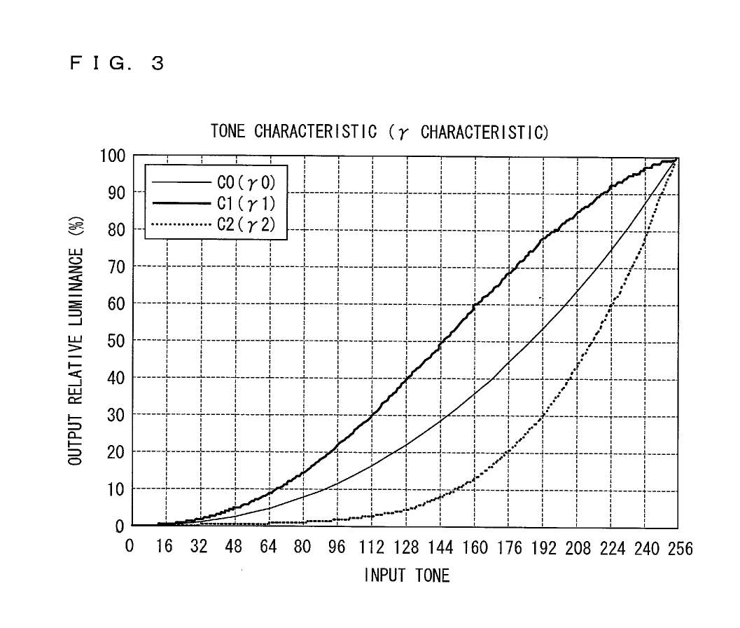

The following description will describe an example of the target gamma curve C0 and the gamma curves C1 and C2 with reference to FIG. 3. FIG. 3 is a graph illustrating an example of a gamma curve used by a driving section in accordance with an embodiment of the present invention.

For example, a relative luminance (output relative luminance) corresponding to an arbitrarily-selected tone on the gamma curve C1 may be higher than a relative luminance corresponding to the arbitrarily-selected tone on the target gamma curve C0 (see FIG. 3). Meanwhile, a relative luminance corresponding to an arbitrarily-selected tone on the gamma curve C2 may be lower than a relative luminance corresponding to the arbitrarily-selected tone on the target gamma curve C0.

With the configuration, the gamma characteristic γ1 of W pixels 44 included in pixels 31 of the pixel group 31a and the gamma characteristic γ2 of W pixels 44 included in pixels 31 of the pixel group 31b are effectively compensated. This makes it possible to obtain excellent visibility when viewed in an oblique direction, and it is therefore possible to further widen a viewing angle.

It is preferable that an average of (i) a relative luminance corresponding to an arbitrarily-selected tone on the gamma curve C1 and (ii) a relative luminance corresponding to the arbitrarily-selected tone on the gamma curve C2 is equal to a relative luminance corresponding to the arbitrarily-selected tone on the target gamma curve C0. This allows visibility viewed from front to be similar to visibility viewed from front in a case where all the W pixels 44 are driven with the use of the target gamma curve C0. Further, it is possible to further improve visibility when viewed in an oblique direction.

Note that the first gamma curve and the second gamma curve are not limited to the example illustrated in FIG. 3 but may be configured, for example, as described below.

For example, the first gamma curve or the second gamma curve may intersect with the target gamma curve C0 at a certain tone. In this case, for example, a relative luminance corresponding to an arbitrarily-selected tone on the first gamma curve or the second gamma curve, which tone is lower than the certain tone, may be higher than a relative luminance corresponding to the arbitrarily-selected tone on the target gamma curve C0. Alternatively, a relative luminance corresponding to an arbitrarily-selected tone on the first gamma curve or the second gamma curve, which tone is higher than the certain tone, may be lower than a relative luminance corresponding to the arbitrarily-selected tone on the target gamma curve C0. A relative luminance outputted by a pixel driven by a gamma curve configured as above becomes higher than a target relative luminance at a low tone and becomes lower than the target relative luminance at a high tone.

In a case where the first gamma curve or the second gamma curve intersects with the target gamma curve C0 at a certain tone, for example, a relative luminance corresponding to an arbitrarily-selected tone on the first gamma curve or the second gamma curve, which tone is lower than the certain tone, may be lower than a relative luminance corresponding to the arbitrarily-selected tone on the target gamma curve C0. Alternatively, a relative luminance corresponding to an arbitrarily-selected tone on the first gamma curve or the second gamma curve, which tone is higher than the certain tone, may be higher than a relative luminance corresponding to the arbitrarily-selected tone on the target gamma curve C0. A relative luminance outputted by a pixel driven by a gamma curve configured as above becomes lower than a target relative luminance at a low tone and becomes higher than the target relative luminance at a high tone.

A tone at which the first gamma curve intersects with the target gamma curve C0 may be identical with or different from a tone at which the second gamma curve intersects with the target gamma curve C0. Note that, in a case where the tones at which the first and second gamma curves intersect with the target gamma curve C0 are identical with each other, a gamma characteristic of a pixel driven by the first gamma curve and a gamma characteristic of a pixel driven by the second gamma curve are mutually compensated. This makes it possible to obtain excellent visibility when viewed in an oblique direction, and it is therefore possible to widen a viewing angle.

In Embodiment 1, the W pixels 44 are configured to be driven with the use of any of the two gamma curves. Note, however, that the present invention is not limited to this configuration, and a configuration may be employed in which any of three or more gamma curves is used.

### Embodiment 2

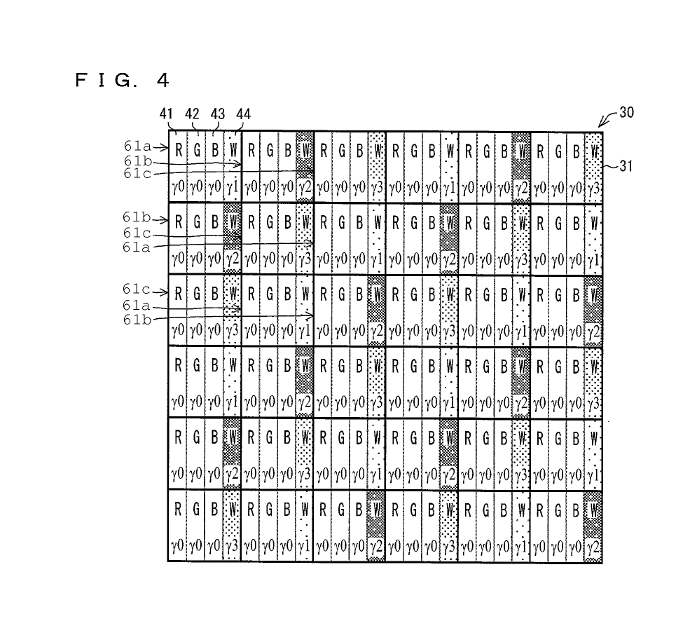

The following description will discuss another embodiment of the present invention in detail, with reference to FIG. 4. FIG. 4 is a view illustrating a display area in accordance with another embodiment of the present invention.

A display device 1 of Embodiment 2 is different from Embodiment 1 only in a method with which pixels are driven by a driving section 20, in particular, different in a predetermined condition on which a tone characteristic adjusting section 52 associates each W pixel 44 with any of a plurality of gamma curves. For convenience, the same reference numerals are given to constituent members having functions similar to those in Embodiment 1, and descriptions as to such constituent members are omitted here. In Embodiment 2, differences from Embodiment 1 are mainly described.

(Pixel Groups 61a and 61b)

In Embodiment 2, a plurality of pixels 31 includes a pixel group (first pixel group) 61a, a pixel group (second pixel group) 61b, and a pixel group (third pixel group) 61c. The pixel group 61a, the pixel group 61b, and the pixel group 61c are disposed in respective different locations. In a display area 30, pixel sets, in each of which pixels 31 of the pixel group 61a, pixels 31 of the pixel group 61b, and pixels 31 of the pixel group 61c are arranged in this order, are consecutively arranged in row and column directions.

In this arrangement, a certain pixel 31 and adjacent pixels 31 adjacent to the certain pixel 31 belong to respective different ones of the pixel groups 61a, 61b, and 61c. In other words, two pixels 31, which belong to an identical one of the pixel group 61a, 61b, and 61c, are not directly adjacent to each other.

(Driving Method)

The driving section 20 drives an R pixel 41, a G pixel 42, and a B pixel 43 with the use of a target gamma curve C0 having a target gamma characteristic γ0.

A tone characteristic adjusting section 52 of the driving section 20 associates, on a condition predetermined as below, each of W pixels 44 with any of three gamma curves, i.e., the gamma curve C1, the gamma curve C2, and a gamma curve (third gamma curve) C3 having a gamma characteristic (third gamma characteristic) γ3 that is different from both the gamma characteristics γ1 and γ2.

In accordance with the condition predetermined in Embodiment 2, the tone characteristic adjusting section (i) associates W pixels 44 included in pixels 31 belonging to the pixel group 61a with the gamma curve C1, (ii) associates W pixels 44 included in pixels 31 belonging to the pixel group 61b with the gamma curve C2, and (iii) associates W pixels 44 included in pixels 31 belonging to the pixel group 61c with the gamma curve C3.

That is, the driving section 20 (i) drives W pixels 44 included in pixels 31 belonging to the pixel group 61a with the use of the gamma curve C1, (ii) drives W pixels 44 included in pixels 31 belonging to the pixel group 61b with the use of the gamma curve C2, and (iii) drives W pixels 44 included in pixels 31 belonging to the pixel group 61c with the use of the gamma curve C3. In other words, the driving section 20 drives, for each location, the W pixels 44 with the use of any of the gamma curves C1, C2, and C3.

With the configuration, the driving section 20 drives the W pixels 44 by a halftone grayscale method with the use of the gamma curves C1 through C3 having the respective different gamma characteristics, i.e., the gamma characteristics γ1, γ2, and γ3. This makes it possible to further enhance the effect of mutual compensation of gamma characteristics of the W pixels 44 and to further improve a viewing angle.

Note that, in a case where the driving section 20 carries out driving with the driving method above described, the driving section 20 may drive the W pixels 44 with the use of an identical gamma curve in all frames or with the use of different gamma curves for each frame. An example will be described in Embodiment in which the driving method of Embodiment 2 is combined with a driving method carried out with the use of different gamma curves for each frame.

Note that the gamma curve C3 may be equal to the target gamma curve C0. In a case where two gamma curves are “equal” to each other, this wording encompasses not only a case where the two gamma curves are completely identical with each other but also a case where a substantially identical effect is brought about even though the two gamma curves are not completely identical with each other. In this case, the driving section 20 (i) drives some of W pixels 44 by a halftone grayscale method with the use of the gamma curves C1 and C2 and (ii) drives the other of W pixels 44 with the use of the target gamma curve C0.

The gamma curve C3 may be (i) a gamma curve on which an arbitrarily-selected tone corresponds to a relative luminance that is lower than a relative luminance corresponding to the arbitrarily-selected tone on the gamma curve C0 or (ii) a gamma curve on which an arbitrarily-selected tone corresponds to a relative luminance that is higher than a relative luminance corresponding to the arbitrarily-selected tone on the gamma curve C0.

The gamma curve C3 may be configured, for example, as described below.

For example, the gamma curve C3 may intersect with the target gamma curve C0 at a certain tone. In this case, a relative luminance corresponding to an arbitrarily-selected tone on the gamma curve C3, which tone is lower than the certain tone, may be lower than a relative luminance corresponding to the arbitrarily-selected tone on the target gamma curve C0. Alternatively, a relative luminance corresponding to an arbitrarily-selected tone on the gamma curve C3, which tone is higher than the certain tone, may be higher than a relative luminance corresponding to the arbitrarily-selected tone on the target gamma curve C0.

In a case where the gamma curve C3 intersects with the target gamma curve C0 at a certain tone, a relative luminance corresponding to an arbitrarily-selected tone on the gamma curve C3, which tone is lower than the certain tone, may be higher than a relative luminance corresponding to the arbitrarily-selected tone on the target gamma curve C0. Alternatively, a relative luminance corresponding to an arbitrarily-selected tone on the gamma curve C3, which tone is higher than the certain tone, may be lower than a relative luminance corresponding to the arbitrarily-selected tone on the target gamma curve C0.

In Embodiment 2, the W pixels 44 are configured to be driven by the driving section 20 with the use of any of the three gamma curves. Note, however, that the present invention is not limited to this configuration, and a configuration may be employed in which any of four or more gamma curves is used.

### Embodiment 3

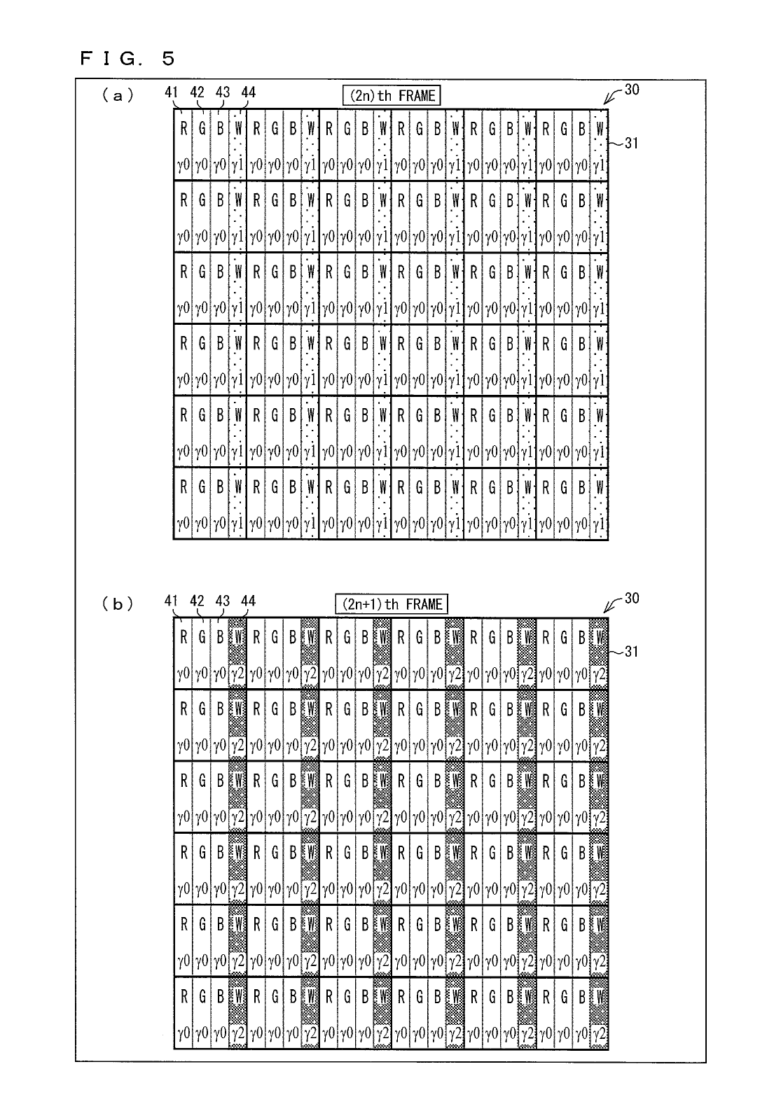

Next, another embodiment of the present invention is described in detail with reference to (a) and (b) of FIG. 5. (a) and (b) of FIG. 5 are diagrams each illustrating a display area of a display device in accordance with another embodiment of the present invention. (a) of FIG. 5 illustrates a display area 30 in a (2n)th frame, and (b) of FIG. 5 illustrates the display area 30 in a (2n+1)th frame.

A display device 1 of Embodiment 3 is different from those of Embodiments 1 and 2 only in a method with which pixels 31 are driven by a driving section 20, in particular, different in a predetermined condition on which a tone characteristic adjusting section 52 associates each of W pixels 44 with any of a plurality of gamma curves. For convenience, the same reference numerals are given to constituent members having functions similar to those in Embodiments 1 and 2, and descriptions as to such constituent members are omitted here. In Embodiment 3, differences from Embodiments 1 and 2 are mainly described.

The driving section 20 drives an R pixel 41, a G pixel 42, and a B pixel 43 with the use of a target gamma curve C0 having a target gamma characteristic γ0.

In Embodiment 3, for each frame, a tone characteristic adjusting section 52 associates, on a condition predetermined as below, each of the W pixels 44 with any of gamma curves C1 and C2.

In accordance with the condition predetermined in Embodiment 3, in a case where the tone characteristic adjusting section 52 associates the W pixels 44 with the gamma curve C1 in a (2n)th frame (a frame followed by a certain frame), the tone characteristic adjusting section 52 associates the W pixels 44 with the gamma curve C2 in a (2n+1)th frame (the certain frame). Meanwhile, in a case where the tone characteristic adjusting section 52 associates the W pixels 44 with the gamma curve C2 in the (2n)th frame, the tone characteristic adjusting section 52 associates the W pixels 44 with the gamma curve C1 in the (2n+1)th frame.

That is, in a case where the driving section 20 drives the W pixels 44 with the use of the gamma curve C1 in the (2n)th frame, the driving section 20 drives the W pixels 44 with the use of the gamma curve C2 in the (2n+1)th frame. Meanwhile, in a case where the driving section 20 drives the W pixels 44 with the use of the gamma curve C2 in the (2n)th frame, the driving section 20 drives the W pixels 44 with the use of the gamma curve C1 in the (2n+1)th frame.

In other words, the driving section 20 drives, for each frame, all of the W pixels 44 by a halftone grayscale method with the use of any of the two different gamma curves C1 and C2.

With the configuration, the W pixels 44 are driven by alternately using the two different gamma curves C1 and C2 for each frame. This brings about an effect of viewing angle compensation in a time axis. This allows (i) visibility viewed in an oblique direction to be further improved and (ii) a video to be displayed further smoothly. Further, deterioration in resolution feeling can be prevented.

(a) and (b) of FIG. 5 each illustrates a case where the driving section 20 drives, in one (1) frame, all of the W pixels 44 in the display area 30 with the use of an identical gamma curve. However, the present invention is not limited to this. Apart from the aforementioned driving method, the driving section 20 may drive, in one (1) frame, some of the plurality of W pixels 44 with the use of a gamma curve different from a gamma curve used to drive the other W pixels 44. For example, the configuration in Embodiment 1 and the configuration in Embodiment 3 may be combined. An example of such a combination will be described in Embodiment 5.

### Embodiment 4

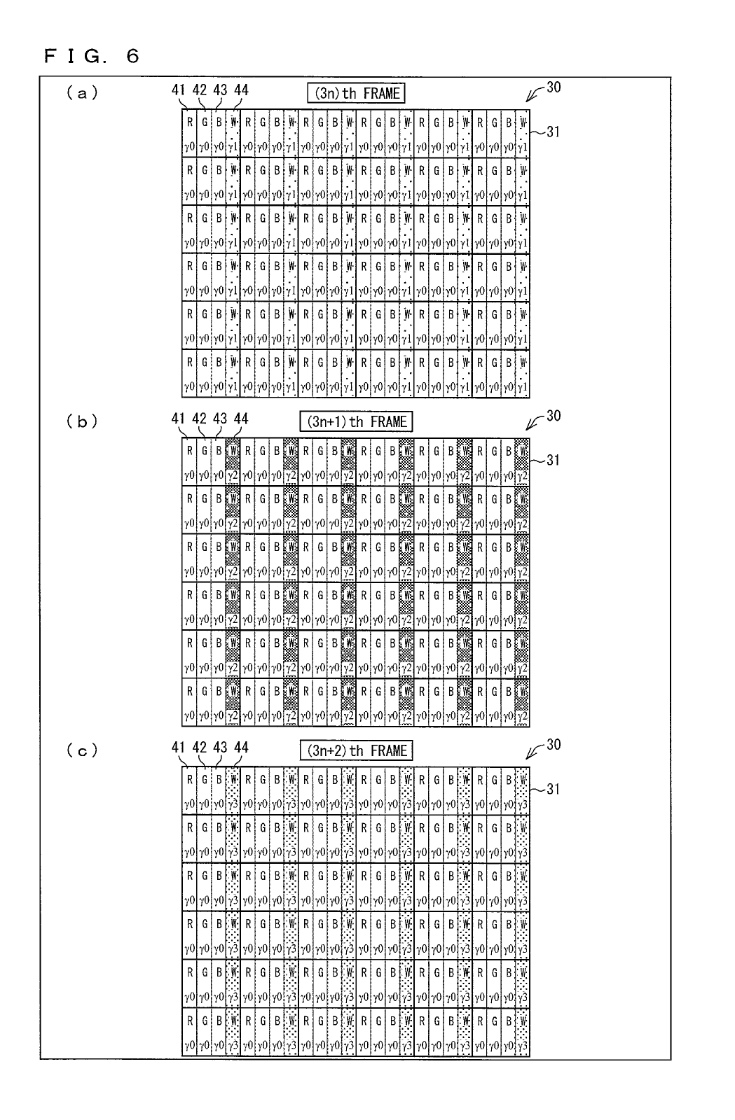

Next, another embodiment of the present invention is described in detail with reference to (a) through (c) of FIG. 6. (a) through (c) of FIG. 6 are views each illustrating a display area of a display device in accordance with another embodiment of the present invention. (a) of FIG. 6 illustrates a display area 30 in a (3n)th frame. (b) of FIG. 6 illustrates the display area 30 in a (3n+1)th frame. (c) of FIG. 6 illustrates the display area 30 in a (3n+2)th frame.

A display device 1 of Embodiment 4 is different from those of Embodiments 1 through 3 only in a method with which pixels 31 are driven by a driving section 20, in particular, different in a predetermined condition on which a tone characteristic adjusting section 52 associates each W pixel 44 with any of a plurality of gamma curves. For convenience, the same reference numerals are given to constituent members having functions similar to those in Embodiments 1 through 3, and descriptions as to such constituent members are omitted here. In Embodiment 4, differences from Embodiments 1 through 3 are mainly described. The driving section 20 drives an R pixel 41, a G pixel 42, and a B pixel 43 with the use of a target gamma curve C0 having a target gamma characteristic γ0.

In Embodiment 4, for each frame, the tone characteristic adjusting section 52 associates, on a condition predetermined as below, the W pixels 44 with any of three gamma curves, i.e., a gamma curve C1, a gamma curve C2, and a gamma curve C3.

In accordance with the condition predetermined in Embodiment 4, in a case where the tone characteristic adjusting section 52 associates the W pixels 44 with the gamma curve C1 in a (3n)th frame (a frame followed by a certain frame), the tone characteristic adjusting section 52 associates the W pixels 44 with the gamma curve C2 in a (3n+1)th frame (the certain frame). Meanwhile, in a case where the tone characteristic adjusting section 52 associates the W pixels 44 with the gamma curve C2 in the (3n)th frame, the tone characteristic adjusting section 52 associates the W pixels 44 with the gamma curve C3 in the (3n+1)th frame. Meanwhile, in a case where the tone characteristic adjusting section 52 associates the W pixels 44 with the gamma curve C3 in the (3n)th frame, the tone characteristic adjusting section 52 associates the W pixels 44 with the gamma curve C1 in the (3n+1)th frame.

That is, in a case where the driving section 20 drives the W pixels 44 with the use of the gamma curve C1 in the (3n)th frame, the driving section 20 drives the W pixels 44 with the use of the gamma curve C2 in the (3n+1)th frame. Meanwhile, in a case where the driving section 20 drives the W pixels 44 with the use of the gamma curve C2 in the (3n)th frame, the driving section 20 drives the W pixels 44 with the use of the gamma curve C3 in the (3n+1)th frame. Meanwhile, in a case where the driving section 20 drives the W pixels 44 with the use of the gamma curve C3 in the (3n)th frame, the driving section 20 drives the W pixels 44 with the use of the gamma curve C1 in the (3n+1)th frame.

In other words, the driving section 20 drives, for each frame, the W pixels 44 by a halftone grayscale method with the use of any of the three different gamma curves C1 through C3. Note, however, that Embodiment 4 is not limited to this configuration. Alternatively, the W pixels 44 may be driven, for each frame, by a halftone grayscale method with the use of any of four or more different gamma curves.

With the configuration, the W pixels 44 are driven by using the three different gamma curves C1 through C3 by rotation for each frame. This brings about an effect of viewing angle compensation in a time axis. This allows (i) visibility viewed in an oblique direction to be further improved and (ii) a video to be displayed further smoothly. Further, deterioration in resolution feeling can be prevented.

Note that the gamma curve C3 may be equal to the target gamma curve C0. In this case, the driving section drives some of the W pixels 44 by a halftone grayscale method with the use of the gamma curves C1 and C2, and drives the other W pixels 44 with the use of the target gamma curve C0.

(a) through (c) of FIG. 6 each illustrate a case where the driving section 20 drives, for each frame, all of the W pixels 44 in the display area 30 with the use of an identical gamma curve. However, the present invention is not limited to this. Apart from the aforementioned driving method, the driving section 20 may drive, in one (1) frame, some of the plurality of W pixels 44 with the use of a gamma curve different from a gamma curve used to drive the other W pixels 44. For example, the configuration in Embodiment 2 and the configuration in Embodiment 4 may be combined. An example of such a combination will be described in Embodiment 6.

### Embodiment 5

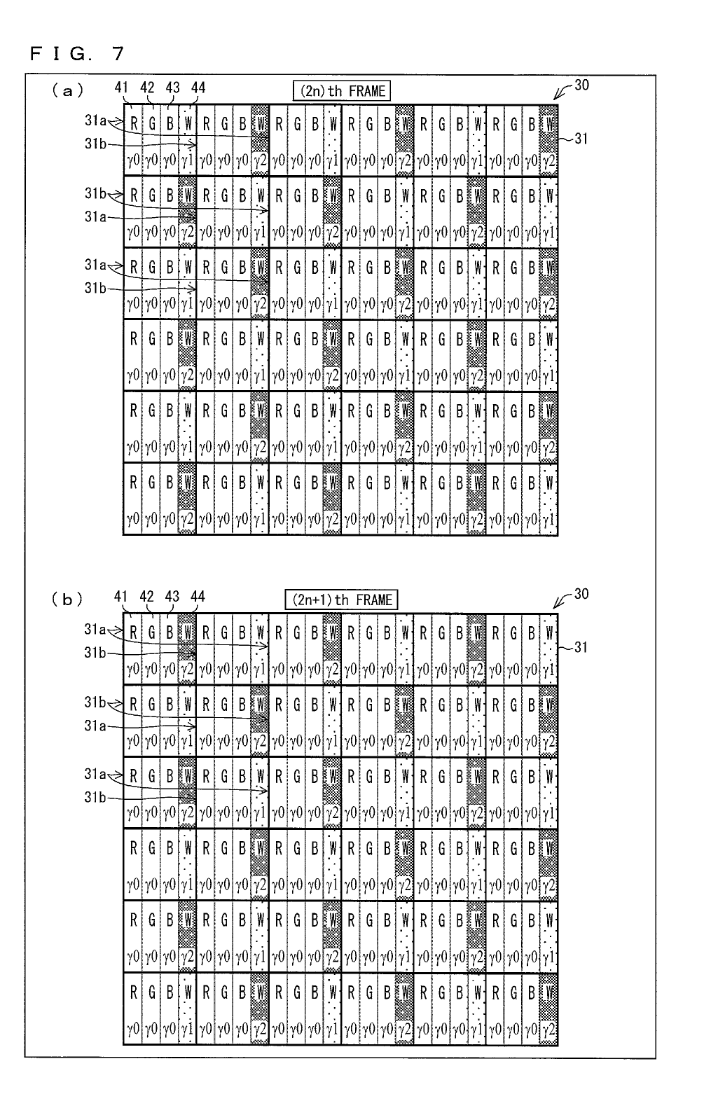

Next, another embodiment of the present invention is described in detail with reference to (a) and (b) of FIG. 7. (a) and (b) of FIG. 7 are views each illustrating a display area of a display device in accordance with another embodiment of the present invention. (a) of FIG. 7 illustrates a display area 30 in a (2n)th frame. (b) of FIG. 7 illustrates the display area 30 in a (2n+1)th frame.

A display device 1 of Embodiment 5 is different from those of Embodiments 1 through 4 only in a method with which pixels 31 are driven by a driving section 20, in particular, in a predetermined condition on which a tone characteristic adjusting section 52 associates each of W pixels 44 with any of a plurality of gamma curves. For convenience, the same reference numerals are given to constituent members having functions similar to those in Embodiments 1 through 4, and descriptions as to such constituent members are omitted here. In Embodiment 5, differences from Embodiments 1 through 4 are mainly described.

In Embodiment 5, the plurality of pixels 31 include a pixel group 31a and a pixel group 31b as in Embodiment 1.

The driving section 20 drives an R pixel 41, a G pixel 42, and a B pixel 43 with the use of a target gamma curve C0 having a target gamma characteristic γ0.

The tone characteristic adjusting section 52 associates, on a condition predetermined as below, the W pixels 44 with any of two gamma curves, i.e., a gamma curve C1 and a gamma curve C2.

In accordance with the condition predetermined in Embodiment 5, in a case where the tone characteristic adjusting section 52 associates W pixels 44 included in pixels 31 belonging to the pixel group 31a with the gamma curve C1, the tone characteristic adjusting section 52 associates W pixels 44 included in pixels 31 belonging to the pixel group 31b with the gamma curve C2, as in Embodiment 1. Meanwhile, in a case where the tone characteristic adjusting section 52 associates the W pixels 44 included in the pixels 31 belonging to the pixel group 31a with the gamma curve C2, the tone characteristic adjusting section 52 associates the W pixels 44 included in the pixels 31 belonging to the pixel group 31b with the gamma curve C1.

That is, in a case where the driving section 20 drives the W pixels 44 included in the pixels 31 belonging to the pixel group 31a with the use of the gamma curve C1, the driving section 20 drives the W pixels 44 included in the pixels 31 belonging to the pixel group 31b with the use of the gamma curve C2. Meanwhile, in a case where the driving section 20 drives the W pixels 44 included in the pixels 31 belonging to the pixel group 31a with the use of the gamma curve C2, the driving section 20 drives the W pixels 44 included in the pixels 31 belonging to the pixel group 31b with the use of the gamma curve C1.

Further, in a case where the tone characteristic adjusting section 52, in a (2n)th frame (a frame followed by a certain frame), drives the W pixels 44 included in the pixels 31 belonging to the pixel group 31a with the use of the gamma curve C1 and drives the W pixels 44 included in the pixels 31 belonging to the pixel group 31b with the use of the gamma curve C2, the tone characteristic adjusting section 52, in a (2n+1)th frame (the certain frame), drives the W pixels 44 included in the pixels 31 belonging to the pixel group 31a with the use of the gamma curve C2 and drives the W pixels 44 included in the pixels 31 belonging to the pixel group 31b with the use of the gamma curve C1.

Meanwhile, in a case where the tone characteristic adjusting section 52, in the (2n)th frame, drives the W pixels 44 included in the pixels 31 belonging to the pixel group 31a with the use of the gamma curve C2 and drives the W pixels 44 included in the pixels 31 belonging to the pixel group 31b with the use of the gamma curve C1, the tone characteristic adjusting section 52, in the (2n+1)th frame, drives the W pixels 44 included in the pixels 31 belonging to the pixel group 31a with the use of the gamma curve C1 and drives the W pixels 44 included in the pixels 31 belonging to the pixel group 31b with the use of the gamma curve C2.

That is, the driving section 20 drives, for each location and for each frame, all of the W pixels 44 by a halftone grayscale method with the use of any of the two different gamma curves C1 and C2.

This makes it possible to (i) further enhance the effect of mutual compensation of gamma characteristics of the W pixels 44 in one (1) frame, (ii) further improve a viewing angle characteristic, and (iii) bring about an effect of viewing angle compensation in a time axis. This allows (i) visibility viewed in an oblique direction to be further improved and (ii) a video to be displayed further smoothly. Further, deterioration in resolution feeling can be prevented.

### Embodiment 6

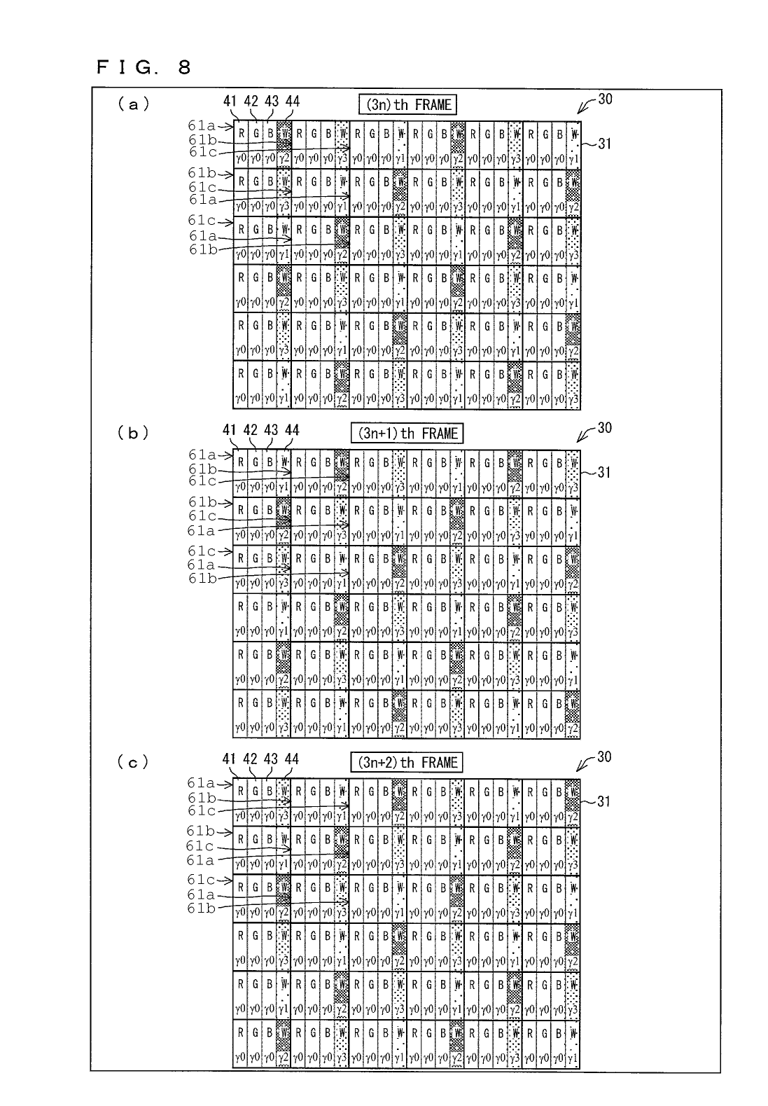

Next, another embodiment of the present invention is described in detail with reference to (a) through (c) of FIG. 8. (a) through (c) of FIG. 8 are views each illustrating a display area of a display device in accordance with another embodiment of the present invention. (a) of FIG. 8 illustrates a display area 30 in a (3n)th frame. (b) of FIG. 8 illustrates the display area 30 in a (3n+1)th frame. (c) of FIG. 8 illustrates the display area 30 in a (3n+2)th frame.

A display device 1 of Embodiment 6 is different from those of Embodiments 1 through 5 only in a method with which pixels 31 are driven by a driving section 20, in particular, different in a predetermined condition on which a tone characteristic adjusting section 52 associates each W pixel 44 with any of a plurality of gamma curves. For convenience, the same reference numerals are given to constituent members having functions similar to those in Embodiments 1 through 5, and descriptions as to such constituent members are omitted here. In Embodiment 6, differences from Embodiments 1 through 5 are mainly described.

In Embodiment 6, each of the plurality of pixels 31 belongs to a pixel group 61a, a pixel group 61b, or a pixel group 61c, as in Embodiment 2.

The driving section 20 drives an R pixel 41, a G pixel 42, and a B pixel 43 with the use of a target gamma curve C0 having a target gamma characteristic γ0.

The tone characteristic adjusting section 52 associates, on a condition predetermined as below, the W pixels 44 with any of three gamma curves, i.e., a gamma curve C1, a gamma curve C2, and a gamma curve C3.

In accordance with the condition predetermined in Embodiment 6, the tone characteristic adjusting section associates (i) W pixels 44 included in pixels 31 belonging to the pixel group 61a, (ii) W pixels 44 included in pixels 31 belonging to the pixel group 61b, and (iii) W pixels 44 included in pixels 31 belonging to the pixel group 61c with respective different gamma curves (the gamma curves C1, C2, and C3).

Further, in accordance with the condition predetermined in Embodiment 6, in a case where the tone characteristic adjusting section 52, in a (3n)th frame (a frame followed by a certain frame), (i) associates the W pixels 44 included in the pixels 31 belonging to the pixel group 61a with the gamma curve C1, (ii) associates the W pixels 44 included in the pixels 31 belonging to the pixel group 61b with the gamma curve C2, and (iii) associates the W pixels 44 included in the pixels 31 belonging to the pixel group 61c with the gamma curve C3, the tone characteristic adjusting section 52, in a (3n+1)th frame (the certain frame), (i) associates the W pixels 44 included in the pixels 31 belonging to the pixel group 61a with the gamma curve C2, (ii) associates the W pixels 44 included in the pixels 31 belonging to the pixel group 61b with the gamma curve C3, and (iii) associates the W pixels 44 included in the pixels 31 belonging to the pixel group 61c with the gamma curve C1.

Meanwhile, in a case where the tone characteristic adjusting section 52, in the (3n)th frame, (i) associates the W pixels 44 included in the pixels 31 belonging to the pixel group 61a with the gamma curve C2, (ii) associates the W pixels 44 included in the pixels 31 belonging to the pixel group 61b with the gamma curve C3, and (iii) associates the W pixels 44 included in the pixels 31 belonging to the pixel group 61c with the gamma curve C1, the tone characteristic adjusting section 52, in the (3n+1)th frame, (i) associates the W pixels 44 included in the pixels 31 belonging to the pixel group 61a with the gamma curve C3, (ii) associates the W pixels 44 included in the pixels 31 belonging to the pixel group 61b with the gamma curve C1, and (iii) associates the W pixels 44 included in the pixels 31 belonging to the pixel group 61c with the gamma curve C2.

Meanwhile, in a case where the tone characteristic adjusting section 52, in the (3n)th frame, (i) associates the W pixels 44 included in the pixels 31 belonging to the pixel group 61a with the gamma curve C3, (ii) associates the W pixels 44 included in the pixels 31 belonging to the pixel group 61b with the gamma curve C1, and (iii) associates the W pixels 44 included in the pixels 31 belonging to the pixel group 61c with the gamma curve C2, the tone characteristic adjusting section 52, in the (3n+1)th frame, (i) associates the W pixels 44 included in the pixels 31 belonging to the pixel group 61a with the gamma curve C1, (ii) associates the W pixels 44 included in the pixels 31 belonging to the pixel group 61b with the gamma curve C2, and (iii) associates the W pixels 44 included in the pixels 31 belonging to the pixel group 61c with the gamma curve C3.

That is, in a case where the driving section 20, in a (3n)th frame (a frame followed by a certain frame), (i) drives the W pixels 44 included in the pixels 31 belonging to the pixel group 61a with the use of the gamma curve C1, (ii) drives the W pixels 44 included in the pixels 31 belonging to the pixel group 61b with the use of the gamma curve C2, and (iii) drives the W pixels 44 included in the pixels 31 belonging to the pixel group 61c with the use of the gamma curve C3, the driving section 20, in a (3n+1)th frame (the certain frame), (i) drives the W pixels 44 included in the pixels 31 belonging to the pixel group 61a with the use of the gamma curve C2, (ii) drives the W pixels 44 included in the pixels 31 belonging to the pixel group 61b with the use of the gamma curve C3, and (iii) drives the W pixels 44 included in the pixels 31 belonging to the pixel group 61c with the use of the gamma curve C1.

Meanwhile, in a case where the driving section 20, in the (3n)th frame, (i) drives the W pixels 44 included in the pixels 31 belonging to the pixel group 61a with the use of the gamma curve C2, (ii) drives the W pixels 44 included in the pixels 31 belonging to the pixel group 61b with the use of the gamma curve C3, and (iii) drives the W pixels 44 included in the pixels 31 belonging to the pixel group 61c with the use of the gamma curve C1, the driving section 20, in the (3n+1)th frame, (i) drives the W pixels 44 included in the pixels 31 belonging to the pixel group 61a with the use of the gamma curve C3, (ii) drives the W pixels 44 included in the pixels 31 belonging to the pixel group 61b with the use of the gamma curve C1, and (iii) drives the W pixels 44 included in the pixels 31 belonging to the pixel group 61c with the use of the gamma curve C2.

Meanwhile, in a case where the driving section 20, in the (3n)th frame, (i) drives the W pixels 44 included in the pixels 31 belonging to the pixel group 61a with the use of the gamma curve C3, (ii) drives the W pixels 44 included in the pixels 31 belonging to the pixel group 61b with the use of the gamma curve C1, and (iii) drives the W pixels 44 included in the pixels 31 belonging to the pixel group 61c with the use of the gamma curve C2, the driving section 20, in the (3n+1)th frame, (i) drives the W pixels 44 included in the pixels 31 belonging to the pixel group 61a with the use of the gamma curve C1, (ii) drives the W pixels 44 included in the pixels 31 belonging to the pixel group 61b with the use of the gamma curve C2, and (iii) drives the W pixels 44 included in the pixels 31 belonging to the pixel group 61c with the use of the gamma curve C3.

That is, the driving section 20 drives, for each location and for each frame, the W pixels 44 by a halftone grayscale method with the use of any of the three different gamma curves C1 through C3. Note, however, that Embodiment 6 is not limited to this configuration. Alternatively, the driving section 20 may drive the W pixels 44 by a halftone grayscale method with the use of four or more different gamma curves.

With the configuration, the driving section 20 drives the W pixels 44 included in the three pixel groups that are disposed in respective different locations, i.e., (i) the W pixels 44 included in the pixel group 61a, (ii) the W pixels 44 included in the pixel group 61b, and (iii) the W pixels 44 included in the pixel group 61c with the use of the three gamma curves C1 through C3 having respective different gamma characteristics γ1, γ2, and γ3, respectively. Further, the driving section 20 drives the W pixels 44 with the use of the three different gamma curves C1 through C3 for each frame.

This makes it possible to (i) further enhance the effect of mutual compensation of gamma characteristics of the W pixels 44 in one (1) frame, (ii) further improve a viewing angle characteristic, and (iii) bring about an effect of viewing angle compensation in a time axis. This allows (i) visibility viewed in an oblique direction to be further improved and (ii) a video to be displayed further smoothly. Further, deterioration in resolution feeling can be prevented.

### Embodiment 7

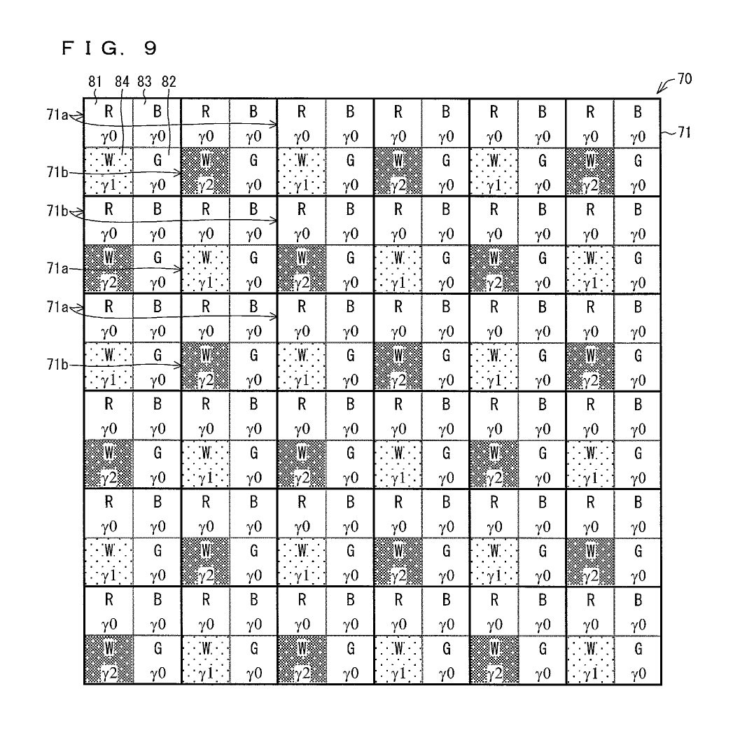

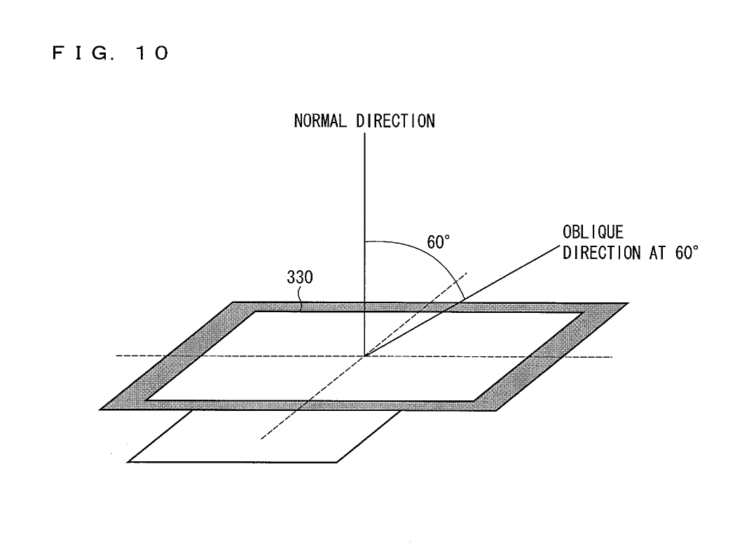

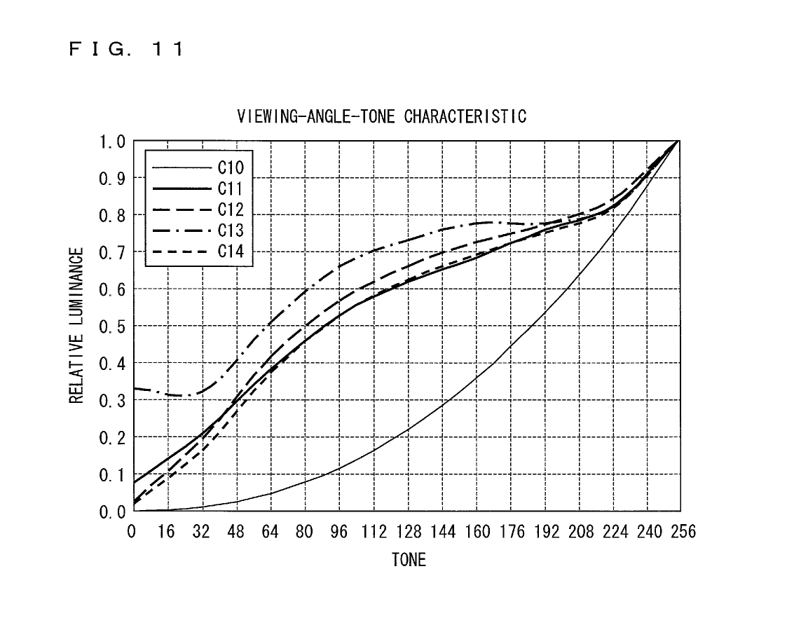

Next, another embodiment of the present invention is described in detail with reference to FIG. 9. FIG. 9 is a view illustrating a display area 70 in accordance with another embodiment of the present invention.

The display device of Embodiment 7 is different from that of Embodiment 1 only in how a first subpixel and a second subpixel are disposed in each pixel. For convenience, the same reference numerals are given to constituent members having functions similar to those in Embodiment 1, and descriptions as to such constituent members are omitted here. In Embodiment 7, differences from Embodiment 1 are mainly described.

(Pixel 71 and Pixel Groups 71a and 71b)

In Embodiment 7, each of a plurality of pixels 71 is made up of an R pixel (first subpixel) 81, a G pixel (first subpixel) 82, a B pixel (first subpixel) 83, and a W pixel (second subpixel) 84. The R pixel 81, the G pixel 82, the B pixel 83, and the W pixel 84 are arranged in a matrix of 2×2 in one (1) pixel 71.

The plurality of pixels 71 include a pixel group (first pixel group) 71a and a pixel group (second pixel group) 71b. The pixel group 71a and the pixel group 71b are disposed in respective different locations. In Embodiment 7, a pixel 71 belonging to the pixel group 71a and a pixel 71 belonging to the pixel group 71b are alternately disposed.

(Driving Method)

A driving section 20 drives the R pixel 81, the G pixel 82, and the B pixel 83 with the use of a target gamma curve C0 having a target gamma characteristic γ0.

A tone characteristic adjusting section 52 in the driving section 20 associates, on a condition predetermined as below, the W pixels 44 with any of gamma curves C1 and C2.

In accordance with the condition predetermined in Embodiment 7, the tone characteristic adjusting section 52 associates W pixels 84 included in pixels 71 belonging to the pixel group 71a with the gamma curve C1 and associates W pixels 84 included in pixels 71 belonging to the pixel group 71b with the gamma curve C2.

That is, the driving section 20 drives the W pixels 84 included in the pixels 71 belonging to the pixel group 71a with the use of the gamma curve C1 and drives the W pixels 84 included in the pixels 71 belonging to the pixel group 71b with the use of the gamma curve C2. That is, the driving section 20 drives, for each location, the W pixels 84 by a halftone grayscale method with the use of any of the two different gamma curves C1 and C2.

With the configuration, the driving section 20 drives the W pixels 84 by a halftone grayscale method with the use of the two gamma curves C1 and C2 having respective different gamma characteristics γ1 and γ2. This makes it possible to further enhance the effect of mutual compensation of gamma characteristics of the W pixels 84 and to further improve a viewing angle.

Note that, in a case where the driving section 20 carries out driving with the driving method above described, the driving section 20 may drive W pixels 84 with the use of an identical gamma curve in all frames or with the use of different gamma curves for each frame. In Embodiment 7, the W pixels 84 are configured to be driven with the use of any of the two gamma curves. Note, however, that the present invention is not limited to this configuration, and a configuration may be employed in which any of three or more gamma curves is used.

Embodiment 7 has discussed a configuration in which the plurality of pixels 71 includes the two pixel groups 71a and 71b. However, the present invention is not limited to this configuration. Alternatively, such a configuration is also possible in which the plurality of pixels 71 include three or more pixel groups.

[Additional Remark]

The present invention is not limited to the embodiments, but can be altered by a skilled person in the art within the scope of the claims. An embodiment derived from a proper combination of technical means disclosed in respective different embodiments is also encompassed in the technical scope of the present invention.

For example, according to the display device of the present invention, it is preferable that the plurality of pixels include a plurality of pixel groups which are disposed in respective different locations; the driving means drives second subpixels, which are included in pixels of a first pixel group in the plurality of pixel groups, with use of the first gamma curve; and the driving means drives second subpixels, which are included in pixels of a second pixel group in the plurality of pixel groups, with use of the second gamma curve.

According to the configuration, the driving means drives second subpixels included in pixels of each of a plurality of pixel groups, which are disposed in respective different locations, with the use of any of the plurality of gamma curves including the first gamma curve and the second gamma curve which are different from each other. This makes it possible to enhance the effect of mutual compensation of gamma characteristics of the second subpixels and to improve a viewing angle characteristic.

According to the display device of the present invention, it is preferable that the plurality of pixels include a plurality of pixel groups which are disposed in respective different locations; in a case where the driving means drives, in a frame followed by a certain frame, (i) second subpixels, which are included in pixels of a first pixel group in the plurality of pixel groups, with use of the first gamma curve and (ii) second subpixels, which are included in pixels of a second pixel group in the plurality of pixel groups, with use of the second gamma curve, the driving means drives, in the certain frame, (i) the second subpixels, which are included in the pixels of the first pixel group, with use of the second gamma curve and (ii) the second subpixels, which are included in the pixels of the second pixel group, with use of the first gamma curve; and in a case where the driving means drives, in a frame followed by a certain frame, (i) the second subpixels, which are included in the pixels of the first pixel group, with use of the second gamma curve and (ii) the second subpixels, which are included in the pixels of the second pixel group, with use of the first gamma curve, the driving means drives, in the certain frame, (i) the second subpixels, which are included in the pixels of the first pixel group, with use of the first gamma curve and (ii) the second subpixels, which are included in the pixels of the second pixel group, with use of the second gamma curve.

According to the configuration, the driving means drives second subpixels included in pixels of each of the plurality of pixel groups, which are disposed in respective different locations, with the use of any of the plurality of gamma curves including the first gamma curve and the second gamma curve which are different from each other. Moreover, the driving means drives the second subpixels by alternately using different two gamma curves for each frame. As such, the driving means drives, for each location and for each frame, the second subpixels with the use of any of the plurality of gamma curves.

This makes it possible to (i) further enhance the effect of mutual compensation of gamma characteristics of the second subpixels, (ii) further improve a viewing angle characteristic, and (iii) bring about an effect of viewing angle compensation in a time axis. This allows (i) visibility viewed in an oblique direction to be further improved and (ii) a video to be displayed further smoothly. Further, deterioration in resolution feeling can be further suppressed.

According to the display device of the present invention, it is preferable that the driving means drives second subpixels, which are included in pixels of a third pixel group in the plurality of pixel groups, with use of a third gamma curve that has a third gamma characteristic different from both the first gamma characteristic and the second gamma characteristic.

According to the configuration, the driving means drives second subpixels included in pixels of each of the first pixel group, the second pixel group, and the third pixel group included in the plurality of pixel groups, which are disposed in respective different locations, with the use of any of the plurality of gamma curves including the first gamma curve, the second gamma curve, and the third gamma curve which are different from each other. This allows gamma characteristics of the second subpixels to be mutually compensated, and therefore a viewing angle characteristic can be improved.

According to the display device of the present invention, it is preferable that the plurality of pixels include a plurality of pixel groups which are disposed in respective different locations; in a case where the driving means drives, in a frame followed by a certain frame, (i) second subpixels, which are included in pixels of a first pixel group in the plurality of pixel groups, with use of the first gamma curve, (ii) second subpixels, which are included in pixels of a second pixel group in the plurality of pixel groups, with use of the second gamma curve, and (iii) second subpixels, which are included in pixels of a third pixel group in the plurality of pixel groups, with use of a third gamma curve that is different from both the first gamma characteristic and the second gamma characteristic, the driving means drives, in the certain frame, (i) the second subpixels, which are included in the pixels of the first pixel group, with use of the second gamma curve, (ii) the second subpixels, which are included in the pixels of the second pixel group, with use of the third gamma curve, and (iii) the second subpixels, which are included in the pixels of the third pixel group, with use of the first gamma curve; in a case where the driving means drives, in a frame followed by a certain frame, (i) the second subpixels, which are included in the pixels of the first pixel group, with use of the second gamma curve, (ii) the second subpixels, which are included in the pixels of the second pixel group, with use of the third gamma curve, and (iii) the second subpixels, which are included in the pixels of the third pixel group, with use of the first gamma curve, the driving means drives, in the certain frame, (i) the second subpixels, which are included in the pixels of the first pixel group, with use of the third gamma curve, (ii) the second subpixels, which are included in the pixels of the second pixel group, with use of the first gamma curve, and (iii) the second subpixels, which are included in the pixels of the third pixel group, with use of the second gamma curve; and in a case where the driving means drives, in a frame followed by a certain frame, (i) the second subpixels, which are included in the pixels of the first pixel group, with use of the third gamma curve, (ii) the second subpixels, which are included in the pixels of the second pixel group, with use of the first gamma curve, and (iii) the second subpixels, which are included in the pixels of the third pixel group, with use of the second gamma curve, the driving means drives, in the certain frame, (i) the second subpixels, which are included in the pixels of the first pixel group, with use of the first gamma curve, (ii) the second subpixels, which are included in the pixels of the second pixel group, with use of the second gamma curve, and (iii) the second subpixels, which are included in the pixels of the third pixel group, with use of the third gamma curve.

According to the configuration, the driving means drives second subpixels included in pixels of each of the plurality of pixel groups, which are disposed in respective different locations, with the use of the plurality of gamma curves including the first gamma curve, the second gamma curve, and the third gamma curve which have respective different gamma characteristics. Moreover, the driving means drives the second subpixels by using different three gamma curves by rotation for each frame. As such, the driving means drives, for each location and for each frame, the second subpixels with the use of any of the plurality of gamma curves.

This makes it possible to (i) further enhance the effect of mutual compensation of gamma characteristics of the second subpixels, (ii) further improve a viewing angle characteristic, and (iii) bring about an effect of viewing angle compensation in a time axis. This allows (i) visibility viewed in an oblique direction to be further improved and (ii) a video to be displayed further smoothly. Further, deterioration in resolution feeling can be further suppressed.

According to the display device of the present invention, it is preferable that, in a case where the driving means drives, in a frame followed by a certain frame, the second subpixels with use of the first gamma curve, the driving means drives, in the certain frame, the second subpixels with use of the second gamma curve; and in a case where the driving means drives, in a frame followed by a certain frame, the second subpixels with use of the second gamma curve, the driving means drives, in the certain frame, the second subpixels with use of the first gamma curve.

According to the configuration, the driving means drives the second subpixels by alternately using different two gamma curves for each frame. This makes it possible to (i) bring about an effect of viewing angle compensation in a time axis, (ii) further improve visibility when viewed in an oblique direction, and (iii) display a video further smoothly. Further, deterioration in resolution feeling can be prevented.

According to the display device of the present invention, it is preferable that, in a case where the driving means drives, in a frame followed by a certain frame, the second subpixels with use of the first gamma curve, the driving means drives, in the certain frame, the second subpixels with use of the second gamma curve; in a case where the driving means drives, in a frame followed by a certain frame, the second subpixels with use of the second gamma curve, the driving means drives, in the certain frame, the second subpixels with use of a third gamma curve which is different from both the first gamma characteristic and the second gamma characteristic; and in a case where the driving means drives, in a frame followed by a certain frame, the second subpixels with use of the third gamma curve, the driving means drives, in the certain frame, the second subpixels with use of the first gamma curve.

According to the configuration, the driving means drives the second subpixels by using different three gamma curves by rotation for each frame. This makes it possible to (i) bring about an effect of viewing angle compensation in a time axis, (ii) further improve visibility when viewed in an oblique direction, and (iii) display a video further smoothly. Further, deterioration in resolution feeling can be prevented.

According to the display device of the present invention, it is preferable that the predetermined gamma characteristic is a target gamma characteristic; a relative luminance corresponding to an arbitrarily-selected tone on the first gamma curve is higher than a relative luminance corresponding to the arbitrarily-selected tone on the common gamma curve; and a relative luminance corresponding to an arbitrarily-selected tone on the second gamma curve is lower than a relative luminance corresponding to the arbitrarily-selected tone on the common gamma curve.

According to the configuration, the plurality of first subpixels that are included in each pixel and are subpixels for displaying respective different colors are uniformly driven by the driving means with the use of the gamma curve having the target gamma characteristic. This makes it possible to further effectively eliminate cases (i) where an oblique line which is to be displayed is not displayed and (ii) where an intended color to be displayed becomes an unintended color.

Moreover, the gamma characteristic of second subpixels driven with the use of the first gamma curve and the gamma characteristic of second subpixels driven with the use of the second gamma curve are effectively compensated, and a viewing angle is therefore further improved.

According to the display device of the present invention, it is preferable that the predetermined gamma characteristic is a target gamma characteristic; a relative luminance corresponding to an arbitrarily-selected tone on the first gamma curve is higher than a relative luminance corresponding to the arbitrarily-selected tone on the common gamma curve; a relative luminance corresponding to an arbitrarily-selected tone on the second gamma curve is lower than a relative luminance corresponding to the arbitrarily-selected tone on the common gamma curve; and the third gamma curve is equal to the common gamma curve.

According to the configuration, the plurality of first subpixels that are included in each pixel and are subpixels for displaying respective different colors are uniformly driven by the driving means with the use of the gamma curve having the target gamma characteristic. This makes it possible to further effectively eliminate cases (i) where an oblique line which is to be displayed is not displayed and (ii) where an intended color to be displayed becomes an unintended color.

Moreover, second subpixels driven with the use of the first gamma curve and second subpixels driven with the use of the second gamma curve are effectively compensated, and a viewing angle is therefore further improved.

Moreover, the third gamma curve is equal to the common gamma curve having the target gamma characteristic. This makes it possible to suppress display of bright and dark dots and to prevent a decrease in resolution that is felt when viewed with eyes (hereinafter, also referred to as “deterioration in resolution feeling”).

According to the display device of the present invention, it is preferable that each of the plurality of pixels includes (i) a red pixel for displaying red, a green pixel for displaying green, and a blue pixel for displaying blue as the plurality of first subpixels and (ii) a white pixel for displaying white as the second subpixel.

According to the configuration, one (1) pixel is made up of a combination of (i) first subpixels for displaying red, green, and blue which are basic three primary colors and (ii) a white pixel for displaying white that is a mixed color obtained by mixing the three primary colors. This makes it possible to reduce the number of subpixels constituting one (1) pixel and to widen a color reproduction range. Further, it is possible to increase transmittance of a display panel.

According to the display device of the present invention, it is preferable that the predetermined gamma characteristic falls within a range between 1.7 and 2.7.

According to the configuration, it is possible to improve visibility.

According to the display device of the present invention, it is preferable that the common gamma curve is a curve having one (1) inflection point.

According to the configuration, it is possible to (i) further enhance the effect of mutual compensation of gamma characteristics and (ii) improve visibility. Moreover, a tone-luminance characteristic of a halftone region which is often used in a natural image is steeply changed, and this makes it possible to heighten contrast that is felt when viewed with eyes (contrast feeling).

According to the display device of the present invention, it is preferable that an average of (i) a relative luminance corresponding to an arbitrarily-selected tone on the first gamma curve and (ii) a relative luminance corresponding to the arbitrarily-selected tone on the second gamma curve is equal to a relative luminance corresponding to the arbitrarily-selected tone on the common gamma curve.

According to the configuration, second subpixels driven with the use of the first gamma curve and second subpixels driven with the use of the second gamma curve are further effectively compensated. This allows a further improvement in viewing angle. Therefore, it is possible to cause visibility viewed from front to be similar to visibility viewed from front in a case where all the second subpixels are driven with the use of the common gamma curve. Further, it is possible to further improve visibility when viewed in an oblique direction.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention makes it possible (i) to display an image that is further similar to an intended image to be displayed and (ii) to prevent color aberration when viewed in an oblique direction at low cost. Therefore, the present invention is widely applicable to devices (e.g., a liquid crystal display device) for displaying an image.

### REFERENCE SIGNS LIST

1: Display device
10: Display panel
20: Driving section (driving means)
30: Display area
31: Pixel
31a: Pixel group (first pixel group)
31b: Pixel group (second pixel group)
41: R pixel (first subpixel, red pixel)
42: G pixel (first subpixel, green pixel)
43: B pixel (first subpixel, blue pixel)
44: W pixel (second subpixel, white pixel)
61a: Pixel group (first pixel group)
61b: Pixel group (second pixel group)
61c: Pixel group (third pixel group)
70: Display area
71: Pixel
71a: Pixel group (first pixel group)
71b: Pixel group (second pixel group)
81: R pixel (first subpixel)
82: G pixel (first subpixel)
83: B pixel (first subpixel)
84: W pixel (second subpixel)
γ0: Target gamma characteristic (predetermined gamma characteristic)
γ1: Gamma characteristic (first gamma characteristic)
γ2: Gamma characteristic (second gamma characteristic)
γ3: Gamma characteristic (third gamma characteristic)
C0: Target gamma curve (common gamma curve)
C1: Gamma curve (first gamma curve)
C2: Gamma curve (second gamma curve)
C3: Gamma curve (third gamma curve)

1. A display device comprising:
a display panel having a plurality of pixels; and
driving means for driving the plurality of pixels,
each of the plurality of pixels being made up of (i) a plurality of first subpixels for displaying respective different colors and (ii) a second subpixel for displaying a mixed color that is obtained by mixing arbitrary ones of the different colors,
the driving means driving the plurality of first subpixels with use of a common gamma curve that has a predetermined gamma characteristic, and
the driving means driving, for each location, each of at least some of the second subpixels with use of any of a plurality of gamma curves including (i) a first gamma curve having a first gamma characteristic that is different from the predetermined gamma characteristic and (ii) a second gamma curve having a second gamma characteristic that is different from both the predetermined gamma characteristic and the first gamma characteristic.

2. The display device as set forth in claim 1, wherein:
the plurality of pixels include a plurality of pixel groups which are disposed in respective different locations;
the driving means drives second subpixels, which are included in pixels of a first pixel group in the plurality of pixel groups, with use of the first gamma curve; and
the driving means drives second subpixels, which are included in pixels of a second pixel group in the plurality of pixel groups, with use of the second gamma curve.

3. The display device as set forth in claim 1, wherein:
the plurality of pixels include a plurality of pixel groups which are disposed in respective different locations;
in a case where the driving means drives, in a frame followed by a certain frame, (i) second subpixels, which are included in pixels of a first pixel group in the plurality of pixel groups, with use of the first gamma curve and (ii) second subpixels, which are included in pixels of a second pixel group in the plurality of pixel groups, with use of the second gamma curve, the driving means drives, in the certain frame, (i) the second subpixels, which are included in the pixels of the first pixel group, with use of the second gamma curve and (ii) the second subpixels, which are included in the pixels of the second pixel group, with use of the first gamma curve; and
in a case where the driving means drives, in a frame followed by a certain frame, (i) the second subpixels, which are included in the pixels of the first pixel group, with use of the second gamma curve and (ii) the second subpixels, which are included in the pixels of the second pixel group, with use of the first gamma curve, the driving means drives, in the certain frame, (i) the second subpixels, which are included in the pixels of the first pixel group, with use of the first gamma curve and (ii) the second subpixels, which are included in the pixels of the second pixel group, with use of the second gamma curve.

4. The display device as set forth in claim 2, wherein:
the driving means drives second subpixels, which are included in pixels of a third pixel group in the plurality of pixel groups, with use of a third gamma curve that has a third gamma characteristic different from both the first gamma characteristic and the second gamma characteristic.

5. The display device as set forth in claim 1, wherein:
the plurality of pixels include a plurality of pixel groups which are disposed in respective different locations;
in a case where the driving means drives, in a frame followed by a certain frame, (i) second subpixels, which are included in pixels of a first pixel group in the plurality of pixel groups, with use of the first gamma curve, (ii) second subpixels, which are included in pixels of a second pixel group in the plurality of pixel groups, with use of the second gamma curve, and (iii) second subpixels, which are included in pixels of a third pixel group in the plurality of pixel groups, with use of a third gamma curve that has a third gamma characteristic different from both the first gamma characteristic and the second gamma characteristic, the driving means drives, in the certain frame, (i) the second subpixels, which are included in the pixels of the first pixel group, with use of the second gamma curve, (ii) the second subpixels, which are included in the pixels of the second pixel group, with use of the third gamma curve, and (iii) the second subpixels, which are included in the pixels of the third pixel group, with use of the first gamma curve;
in a case where the driving means drives, in a frame followed by a certain frame, (i) the second subpixels, which are included in the pixels of the first pixel group, with use of the second gamma curve, (ii) the second subpixels, which are included in the pixels of the second pixel group, with use of the third gamma curve, and (iii) the second subpixels, which are included in the pixels of the third pixel group, with use of the first gamma curve, the driving means drives, in the certain frame, (i) the second subpixels, which are included in the pixels of the first pixel group, with use of the third gamma curve, (ii) the second subpixels, which are included in the pixels of the second pixel group, with use of the first gamma curve, and (iii) the second subpixels, which are included in the pixels of the third pixel group, with use of the second gamma curve; and
in a case where the driving means drives, in a frame followed by a certain frame, (i) the second subpixels, which are included in the pixels of the first pixel group, with use of the third gamma curve, (ii) the second subpixels, which are included in the pixels of the second pixel group, with use of the first gamma curve, and (iii) the second subpixels, which are included in the pixels of the third pixel group, with use of the second gamma curve, the driving means drives, in the certain frame, (i) the second subpixels, which are included in the pixels of the first pixel group, with use of the first gamma curve, (ii) the second subpixels, which are included in the pixels of the second pixel group, with use of the second gamma curve, and (iii) the second subpixels, which are included in the pixels of the third pixel group, with use of the third gamma curve.

6. A display device comprising:
a display panel having a plurality of pixels; and
driving means for driving the plurality of pixels,
each of the plurality of pixels being made up of (i) a plurality of first subpixels for displaying respective different colors and (ii) a second subpixel for displaying a mixed color that is obtained by mixing arbitrary ones of the different colors,
the driving means driving the plurality of first subpixels with use of a common gamma curve that has a predetermined gamma characteristic, and
the driving means driving, for each frame, each of at least some of the second subpixels with use of any of a plurality of gamma curves including (i) a first gamma curve having a first gamma characteristic that is different from the predetermined gamma characteristic and (ii) a second gamma curve having a second gamma characteristic that is different from both the predetermined gamma characteristic and the first gamma characteristic.

7. The display device as set forth in claim 6, wherein:
in a case where the driving means drives, in a frame followed by a certain frame, the second subpixels with use of the first gamma curve, the driving means drives, in the certain frame, the second subpixels with use of the second gamma curve; and
in a case where the driving means drives, in a frame followed by a certain frame, the second subpixels with use of the second gamma curve, the driving means drives, in the certain frame, the second subpixels with use of the first gamma curve.

8. The display device as set forth in claim 6, wherein:
in a case where the driving means drives, in a frame followed by a certain frame, the second subpixels with use of the first gamma curve, the driving means drives, in the certain frame, the second subpixels with use of the second gamma curve;
in a case where the driving means drives, in a frame followed by a certain frame, the second subpixels with use of the second gamma curve, the driving means drives, in the certain frame, the second subpixels with use of a third gamma curve which is different from both the first gamma characteristic and the second gamma characteristic; and
in a case where the driving means drives, in a frame followed by a certain frame, the second subpixels with use of the third gamma curve, the driving means drives, in the certain frame, the second subpixels with use of the first gamma curve.

9. The display device as set forth in claim 4, wherein:
the predetermined gamma characteristic is a target gamma characteristic;
a relative luminance corresponding to an arbitrarily-selected tone on the first gamma curve is higher than a relative luminance corresponding to the arbitrarily-selected tone on the common gamma curve; and
a relative luminance corresponding to an arbitrarily-selected tone on the second gamma curve is lower than a relative luminance corresponding to the arbitrarily-selected tone on the common gamma curve.

10. The display device as set forth in claim 4, wherein:
the predetermined gamma characteristic is a target gamma characteristic;
a relative luminance corresponding to an arbitrarily-selected tone on the first gamma curve is higher than a relative luminance corresponding to the arbitrarily-selected tone on the common gamma curve;
a relative luminance corresponding to an arbitrarily-selected tone on the second gamma curve is lower than a relative luminance corresponding to the arbitrarily-selected tone on the common gamma curve; and
the third gamma curve is equal to the common gamma curve.

11. The display device as set forth in claim 1, wherein:
each of the plurality of pixels includes (i) a red pixel for displaying red, a green pixel for displaying green, and a blue pixel for displaying blue as the plurality of first subpixels and (ii) a white pixel for displaying white as the second subpixel.

12. The display device as set forth in claim 1, wherein:
the predetermined gamma characteristic falls within a range between 1.7 and 2.7.

13. The display device as set forth in claim 1, wherein:
the common gamma curve is a curve having one (1) inflection point.

14. The display device as set forth in claim 1, wherein:
an average of (i) a relative luminance corresponding to an arbitrarily-selected tone on the first gamma curve and (ii) a relative luminance corresponding to the arbitrarily-selected tone on the second gamma curve is equal to a relative luminance corresponding to the arbitrarily-selected tone on the common gamma curve.
